(19) United States
(12) Patent Application Publication
(10) Pub. No.: US 2003/0078037 A1
(43) Pub. Date: Apr. 24, 2003

(54) Methodology for portable wireless devices allowing autonomous roaming across multiple cellular air interface standards and frequencies

(76) Inventors: David T. Auckland, Silver Spring, MD (US); Stewart A. Skomra, Poway, CA (US); Lee Stein, Del Mar, CA (US); David Farber, Landenberg, PA (US)

Correspondence Address: BRINKS HOFER GILSON & LIONE, P.O. BOX 10395, CHICAGO, IL, 60610, US

(21) Appl. No.: 10/205,167

(22) Filed: Jul. 25, 2002

Related U.S. Application Data
(60) Provisional application No. 60/313,365, filed on Aug. 17, 2001.

(51) Int. Cl. H04Q 7/20

(52) U.S. Cl. 455/422; 455/450

(57) ABSTRACT

Subscriber units and base stations of telecommunication systems are equipped with RF to IF (EXA) circuit boards which provide complete flexibility for radio communication. The boards may communicate on any air interface standard (CDMA, TDMA, Bluetooth, 3G cellular, etc.) at any frequency or band of frequencies. Separate, independent forward and reverse channels may be assignment, each having its own air interface and frequency band. When a call is initiated, a set of optimum forward and reverse channels are assigned, taking into account relevant factors such as traffic, subscriber requirements for high speed data, etc., so that the channel assignment is tailored to the current communication needs. Channel assignment is updated as needs change, as other channels become available and at handoff. In a business model, air time on multiple telecommunication systems is sold to subscribers who can use this technology to roam widely. Revenue is also generated from licensing of the EXA circuit boards in subscriber units and in base stations.

### CROSS REFERENCE TO RELATED APPLICATIONS

This application claims priority of U.S. Provisional application serial No. 60/313,365, filed Aug. 17, 2001. This application is related to application Ser. No. 09/866,490, filed May 25, 2001 in the names of D. Auckland, W. McKinzie III, D. McCartney and G. Mendolia and commonly assigned with the present application, which application is incorporated in its entirety herein by reference.

### BACKGROUND

The present invention relates generally to radio communication devices. More particularly, the present invention relates to portable wireless devices which may communicate on multiple frequency bands using multiple air interface standards.

FIG. 1 illustrates a prior art radio 100. Radio designs generally consist of three sections, as illustrated in FIG. 1. The radio 100 includes a digital or baseband section 102, a radio frequency-to-intermediate frequency (RF/IF) section 104 and a radio frequency (RF) section 106. This design is conventionally used for portable or mobile devices such as radio handsets, radiotelephones, cordless, cellular and personal communication system (PCS) phones and personal digital assistants. This design is also used for fixed radio devices such as cellular and PCS infrastructure radios.

In such a radio 100, the baseband section 102 of the radio 100 includes a digital signal processor (DSP) 108 which performs functions such as digital signal processing, audio processing, timing and control, and user interface functionality. The DSP 108 may include other associated logic circuitry and memory for data storage.

The RF/IF section 104 includes a receive module 110, a transmit module 112 and a frequency synthesizer 1 14. The receive module 110 generally includes a low noise amplifier (LNA), frequency downconversion, filtering, demodulation, analog to analog to digital conversion, etc., as indicated in FIG. 1. The transmit module 112 generally includes a frequency upconversion, filter, digital to analog conversion and modulation as indicated in FIG. 1. The synthesizer 114 generates signals at appropriate frequencies for mixing with other signals for upconversion or downconversion. Thus, the RF/IF section translates signals to different frequencies, converts signals from analog to digital form or vice-versa, performs a variety of filtering functions on the signals and modulates or demodulates the signals. Common architectures used in this stage are super-heterodyne radios and direct conversion radios.

The RF section 106 is coupled to one or more antennas 116 and includes a switch or diplexer 118, receive filters 120 and transmit filters 122 and power amplifiers 124. The RF section 106 receives and transmits signals at a carrier frequency via one or more antennas 116, separates the transmit and receive path by either a switch 118 or a filter, amplifies the signals for transmitting in the power amplifier 124, and provides additional RF filtering of the signals in the receive filters 120 and the transmit filters 122, as desired, in either the transmit or receive path.

Design and implementation of baseband functions in current radio equipment is moving to a more software programmable technology. Specific operating features, such as frequency of operation, data coding and decoding, and audio processing may be selected dynamically by changing the data stored in the radio for processing. The IF/RF portion of current radios is moving towards greater hardware integration and component reduction. The success of this evolution is evidenced by a number of RF integrated circuits (RFICs) that are commercially available and capable of accommodating multiple air interface standards, such as Global System for Mobile communication (GSM), Wideband Code Division Multiple Access (W-CDMA), Personal Communication System (PCS) in the US, and IEEE 802.11 and Bluetooth. Bluetooth is a short-range digital data communication standard. Current practice in the design and implementation of an RF section 106 for a radio 100 is to use dedicated hardware for each air interface standard, thus resulting in several parallel paths using functionally equivalent hardware. For example, a dual-mode GSM-WCDMA radiotelephone will include a switch 118, bandpass filters 120, 122 and power amplifier 124 for both standards. Each of these air interface standards defines a unique combination of data coding, modulation, multiple access and transmission/reception frequency.

Typically, the antennas in present mobile phones and other devices are not very efficient, but they are sufficient to support current data rates of 9 to 12 kbps (kilobits per second) for voice communications. In fact, the efficiency of most mobile phone antennas is at most, one half, and in many cases one tenth, the efficiency of a standard dipole. As higher data rates become desired with proposed future applications mobile internet access, multimedia content distribution and streaming interactive video, however, the efficiency of the antenna will become more and more important. Increased antenna efficiency allows reduced transmit power which in turn allows reduced power consumption from the battery which powers the radio. Also, the proposed new applications require new radio communication spectrum with higher channel bandwidths. Thus, the antenna must handle even more frequencies than are currently present. Still further, for consumer and portable products, the trend is toward smaller internal antennas, especially antennas that provide significant reduction of specific absorption rate (SAR).

These requirements imposed on the antenna of higher efficiency, broader band and smaller size tend to be in direct mutual conflict. These requirements cannot be met with conventional antenna designs within the stringent form factors of wireless terminal aesthetics.

Many of today's portable communication devices are multi-mode as well as multi-band, but their hardware and software is fixed. A multimode device operates in conjunction with two or more of the air interface standards such as those described above, such as a dual mode digital GSM and Analog Mobile Phone System (AMPS) radiotelephone. A multiband device operates on two or more bands of radio frequencies, such as a dual band radio telephone operable at GSM frequencies around 900 MHz and Digital Communication System (DCS) frequencies around 1800 MHz. Future devices must be able to function at a large number of frequencies. These include 700 MHz for US third generation (3G) data services (only one of the many proposals currently being considered); 800-900 MHz for GSM/CDMA cellular; 1800-1900 MHz for PCS/DCS; and 2400 MHz for Bluetooth.

Of course, it is possible for a single antenna to cover all of these frequencies, but such an antenna would be too large to fit in or on a handset if its radiation efficiency were desired to approximate 100%. The relationship between antenna size, efficiency and bandwidth is provided by the following equation for maximum achievable gain-bandwidth product:

$$βη = {κ ( \frac{a}{λ} )}^{3} \frac{( 1 - {\vert {S}_{11} \vert}^{2} )}{1 - ( \frac{{R}_{L}}{{R}_{R}} )} \qquad ( 1 )$$

This equation is developed in D. T. Auckland, “Some Observations on Gain, Bandwidth and Efficiency of Circular Apertures”, Atlantic Aerospace Technical Note, 27 Oct. 1994. In this equation, we assume that the antenna is electrically small (a<<λ) so no appreciable directivity is available from the antenna structure and

β is the 3 dB bandwidth of the antenna gain function vs frequency

η is the total antenna efficiency

κ is a constant the depends upon the antenna type (e.g., κ=16 for a thin dipole, κ=70 for a TE₁₀ mode waveguide aperture, etc.)

λ is the wavelength

a is the radius of a sphere that circumscribes the antenna structure

S₁₁ is the reflection coefficient at the antenna input terminals

R_{L} is the total loss resistance of the antenna structure

R_{R} is the radiation resistance of the antenna structure

By using lossy components in the construction of the antenna, we increase R_{L}, which decreases efficiency. Some losses also occur as the user holds a radiotelephone handset in the hand, next to the head, during a call. Both the hand and head absorb and reflect energy. These reflection losses are manifested in the S₁₁ term. Thus, the “in-situ” radiation efficiency of the handset antenna, that is when it is held in the hand near the head, will be less than when it is measured in the handset alone. There is much debate even today concerning how best to measure handset antenna efficiency, and currently no standard and widely accepted procedure for this measurement exists.

The form factors available in today's handsets require that external, and especially internal, antennas be very small. When an antenna is made small with respect to a wavelength (approximately 6 inches at PCS frequencies and approximately 4.5 inches at Bluetooth frequencies), its input impedance can be represented by a simple RLC circuit. When a perfect match is obtained at a single frequency by adding a single inductor (L) or capacitor (C), this represents 100% efficiency of radiation in the lossless case. This efficiency decreases as the frequency is tuned about the resonant frequency. The frequency range corresponding to the 50% efficiency point is the so-called 3 dB, or half power bandwidth. Adding resistive or mismatch losses will decrease this peak efficiency but increase the bandwidth on a one-for-one basis. In other words, halving the efficiency will approximately double the bandwidth.

The results of equation (1) are plotted in FIG. 2, which is a plot of maximum bandwidth versus antenna size for various antenna efficiencies, η. It can be seen that, as the area of the antenna becomes smaller, the bandwidth decreases drastically. For example, the smallest size that would be practical for a 800 MHz antenna having 5 MHz of bandwidth would be a diameter of 1.4 in (1000 mm²) for 100% efficiency. If we let the efficiency drop to 50% (−3 dB) then the diameter could decrease to 1.1 in (650 mm²).

As another example, suppose aesthetics dictate that we can have no more than a quarter of an inch for the antenna. Referring to FIG. 2, this allows 800 KHz of bandwidth at PCS to support 3G data rates of 346 kbps and 2 MHz of bandwidth to support Bluetooth channels at near 100% efficiency. The cellular band at 900 MHz would only have 50 KHz of bandwidth, which would be good enough for voice but probably not data. Efficiency would have to drop dramatically to support higher data rates. Finally, support of 700 MHz would not be feasible for this size of aperture. However, to realize such a small aperture would require significant volume behind the antenna for the feed, transition and matching regions. A method for tuning the antenna also has to be implemented, which requires additional volume for control circuitry.

The curves in FIG. 2 are very useful for understanding initial trades between size, bandwidth and efficiency. The non-ideal, real world situation, however, is much more complicated because the actual installation environment in the handset will absorb and reflect energy, thus affecting bandwidth. Three effects result from this interaction. First, the achievable bandwidth is broadened. Second; the efficiency is decreased. Third, the antenna is de-tuned. The first effect, broadening bandwidth, is a good thing because it may obviate the need for antenna tuning. The third effect of de-tuning the antenna can be compensated for electronically via feedback in the tuning controller. The second effect, decreased efficiency, is the most problematic because, as the antenna is made smaller, it couples more tightly to its environment and it is harder to isolate from the causes of efficiency degradation.

The importance of efficiency in the mobile data link requirement can be quantitatively illustrated by examining the basic equation for signal to noise in Equation 2. Here we consider a radio such as a mobile unit in the presence of N sources, one of whom (j) is of interest, thus making the rest interferers.

$$\frac{{E}_{b}}{{N}_{0} + I} = \frac{{S}_{j} / Δ}{{F}_{N} {kT}_{0} + \frac{1}{β} {\sum }_{{i = 1}_{i * j}}^{N} {S}_{i}} \qquad ( 2 )$$

The signal from each source, measured at the terminals of the mobile antenna, is given by

$${S}_{i} = {{ERP}_{i} ( \frac{λ}{4 π {R}_{0}} )}^{2} {( \frac{{R}_{0}}{{R}_{i}} )}^{n} {η}_{i} {D}_{i} \qquad ( 3 )$$

where, in the above equations,

E_{b}=energy per bit (joules)

Δ=data rate (bits per second)

λ=wavelength of center frequency

Rᵢ=distance from mobile to the i^{th} source

R₀=reference distance before propagation spreading

n=propagation exponent (typically 4)

ERPᵢ=effective radiated power of i^{th} source

ηᵢ=efficiency of mobile antenna in direction i

Dᵢ=directivity of mobile antenna in the direction of the i^{th} source

F_{N}=noise figure of the mobile receiver

k=Boltzman's constant

T₀=thermal noise temperature of receiver

β=bandwidth of the mobile antenna

The signal to noise (plus interference) ratio of a receiver is usually set so that the bit error rate (BER) never falls below some threshold (typically 3 to 8 dB for a BER of 0.01, or 1%, in voice systems). If we consider the noise-limited case of equation 2 (left hand side of the denominator is much larger than the right hand side), an increase in data rate must be accompanied by an increase in either ERP of the source, efficiency or directivity. The first is not possible because most sources will emit near their FCC limits. The third is possible, but to a limited extent because an antenna that occupies a small fraction of a wavelength in size has a limited ability to achieve appreciable pattern gain or directivity.

Some future W-CDMA systems will most likely use multi-user receivers with interference cancellation. These receivers demodulate and strip other spread spectrum users from the received signal. In this scenario, efficiency of the antenna becomes very important.

One further observation on antenna efficiency concerns its impact on battery life. In a typical handset supporting a second generation (2G) cellular or PCS communication system today, the power amplifier of the transmit module consumes approximately 70% of the battery power. CDMA and time division multiple access (TDMA) transmit power amplifiers are typically 33% to 35% efficient while GSM/DCS transmit PAs are 40% to 47% efficient at maximum power outputs. Using a more efficient antenna allows one to use a smaller and less expensive PA that is more efficient at lower power levels. Thus, the drain on the battery will be less and will allow the use of a smaller battery. FIG. 3 shows the effect of increased antenna efficiency on battery life for a number of assumed PA efficiencies. The current state of the art for an internal antenna is a poor 5% efficiency (compared to 15% for an external stub, both cases for hand holding the phone next to a person's head).

The above observations argue the need for an efficient antenna, which is physically and electrically small. However, all passive antennas are subject to a gain-bandwidth product limit. A unique solution to this problem is to create an efficient but tunable narrowband antenna whose instantaneous bandwidth is sufficient for the modulation and data rate, but whose tuning range is sufficient to cover the operational band of interest.

One embodiment of an electrically-small, frequency-reconfigurable antenna is disclosed in U.S. Pat. No. 5,777,581, 5,943,016 and 6,061,025 and illustrated in FIG. 4. FIG. 4 shows top and cross sectional views of a cavity-backed microstrip patch antenna 400. The patch antenna 400 includes a metal patch antenna 402, a number of tuning bars 404 and radio frequency (RF) switches 406. The metal patch antenna 400 is positioned above a substrate 408 having a relative dielectric constant of ∈, and is fed at feed probes 410. The tuning bars 404 are additional printed metal traces next to the metal patch antenna 402. The tuning bars 404 are electrically connected via RF switches 406 to make the patch appear larger (to get a lower frequency of operation) or smaller (to get a higher frequency of operation). Solid state switches, such as pin diodes, can be used to tune the antenna. Other types of switches, such as radio frequency micro-electro-mechanical system (MEMS) switch devices, can be used as well. The antenna 400 permits a large number of tuning states, each having 2 MHz to 4 MHz of 3 dB gain bandwidth, in the ultra-high frequency (UHF) satellite communication (SATCOM) band of 240-320 MHz. In this band, the antenna exhibits +3 dBiC of peak gain (70% efficiency). This antenna is also electrically small at 8 inches (20.32 cm) square by 2 inches (5.08 cm) deep (λ=40 inches).

FIG. 5 illustrates isometric and cross sectional views of another frequency-reconfigurable antenna 500 as described in U.S. provisional application 60/240 544, filed Oct. 12, 2000 and entitled “Tunable Reduced Weight Artificial Dielectric Antenna.” The antenna 500 includes anisotropically-tuned capacitive cards 502, which are periodically arranged to form an artificial dielectric medium as a substrate for a cavity backed microstrip patch antenna 504. An aperture 506 is defined above the cards 502 and includes a first radiating slot 508 and a second radiating slot 510. The cards 502 have arrays of diode strings with parallel ballast resistors 512, biased in series to implement an anisotropically tuned artificial dielectric medium. The illustrated embodiment uses varactor diodes 511. The cards 502 form ohmic contacts 514 with the microstrip patch antenna 504 when assembled. For electrical contact at the bottom of the cavity 516, conductive spring fingers 518 are provided. The bottom of the cavity 516 includes stripline conductors carrying bias voltages for tuning the antenna.

In the antenna 500, a reduced weight artificial dielectric forms the microstrip patch substrate. The artificial dielectric incorporates arrays of voltage-variable capacitors, which can be realized by solid state diodes or RF MEMs components. Application of a DC bias voltage to these arrays results in a change in the effective permittivity of the substrate in the z direction, thus changing the resonant frequency of the microstrip patch 504. A combination of the techniques shown in FIGS. 4 and 5 may be used to further increase the range of frequencies over which the antenna will efficiently operate.

Current wireless devices generally operate on one or two frequency bands but on only a single air interface standard. This is true for portable and mobile devices as well as infrastructure equipment. Radiotelephone service providers have relied on physical installation of antenna sites and antenna constellations to provide coverage for portable devices in a defined geographic area. The service provider operates at licensed frequency bands using the air interface standard of its choice. Subscribers to the service operate complementary portable and mobile units on the same frequency bands and under the same air interface standard.

The industry has evolved to the point where many separate infrastructure sites having physically overlapping coverage patterns have been installed. Some infrastructure equipment of competing service providers is even collocated. Placement of infrastructure sites has been based on service needs and real estate availability. The result is sometimes uneven quality of service from any one service provider. In addition, because of system outages and maintenance, acceptable service is not always available from a particular service provider on a particular system.

Because of the overlapping coverage patterns, when coverage from one preferred service provider is unacceptable or unavailable, coverage from one or more other service providers is often available. However, the other service is on a different frequency band, which may not be contiguous or even close to that of the preferred provider. Also, the air interface standards adopted by the other providers may differ from that of the preferred provider. A different air interface standard requires different timing for transmission and reception, a different data format and a different modulation scheme. Also, the subscriber unit generally will not have a service contract or roaming agreement with the alternative provider. Even though good coverage may be available from an alternative provider, a typical subscriber unit lacks the ability to communicate with the alternative provider.

U.S. Pat. No. 6,185,435 discloses a radio communication apparatus operable on a plurality of communication systems and automatically selects a communication system exhibiting good communication channel quality. Channel quality is measured as a function of received signal strength, received data quality and bit error rate. However, improved performance and system integration must be provided for such a device to be commercially viable.

Accordingly, there is a need for a method and apparatus providing automating sensing, selection and negotiation of frequency band, channel and protocol or air interface standard for transmit and receive functions between wireless nodes.

### BRIEF DESCRIPTION OF SEVERAL VIEWS OF THE DRAWINGS

FIG. 1 is a block diagram showing a prior art radio frequency (RF) system architecture for use in a commercial handset or wireless communication device;

FIG. 2 illustrates the maximum theoretical bandwidth obtainable for antennas of given sizes and various efficiencies;

FIG. 3 is a calculation of the increase in battery life that is obtainable versus the radiation efficiency of the antenna;

FIG. 4 shows an embodiment of a prior art frequency-reconfigurable (tunable) microstrip patch antenna;

FIG. 5 shows an embodiment of a prior art frequency-reconfigurable (tunable) microstrip patch antenna using a tunable artificial dielectric substrate;

FIG. 6 is a block diagram of an analog front end of a radio device;

FIG. 7 is a block diagram illustrating a first embodiment of a radio frequency (RF) system architecture of a programmable radio;

FIG. 8 is a block diagram illustrating an alternative embodiment of an RF system architecture of a programmable radio;

FIG. 9 is a block diagram illustrating another alternative embodiment of an RF system architecture of a programmable radio;

FIG. 10 is a perspective view showing integration of a programmable RF front end component with other components of a wireless communication device;

FIG. 11 shows perspective views of three embodiments of a programmable RF front end component for use with the wireless communications device of FIG. 10;

FIG. 12 is an elevation view of one embodiment of the programmable RF front end of FIG. 10;

FIG. 13 is an RF equivalent circuit for the programmable RF front end of FIG. 9;

FIG. 14 is an elevation view of a second embodiment of the programmable RF front end of FIG. 10;

FIG. 15 is a block diagram of an alternative embodiment of a an RF system architecture of a programmable radio;

FIG. 16 illustrates frequency response curves for an antenna, transmit filter and receive filter;

FIG. 17 is a block diagram of a radiotelephone;

FIG. 18 is a flow diagram illustrating operation of the radiotelephone of FIG. 13;

FIG. 19 is a block diagram of a telecommunication system;

FIG. 20 is a block diagram of a base station for use in a telecommunication network of the telecommunication system of FIG. 19;

FIG. 21 is a block diagram of a subscriber unit for use in a telecommunication network of the telecommunication system of FIG. 19;

FIG. 22 is a block diagram illustrating information flow in a method of operating the telecommunication system of FIG. 19; and

FIG. 23 is a flow diagram illustrating operation of the telecommunication system of FIG. 19.

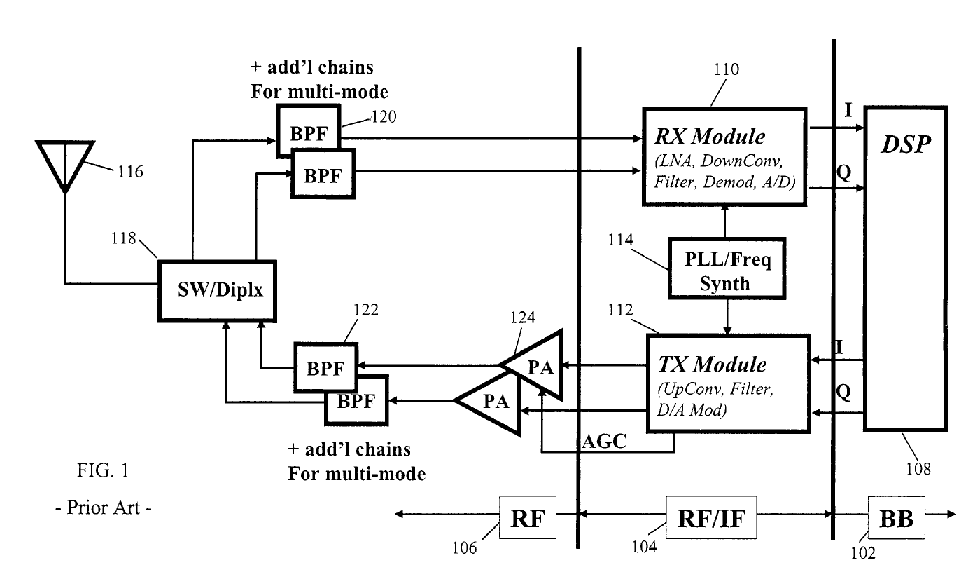

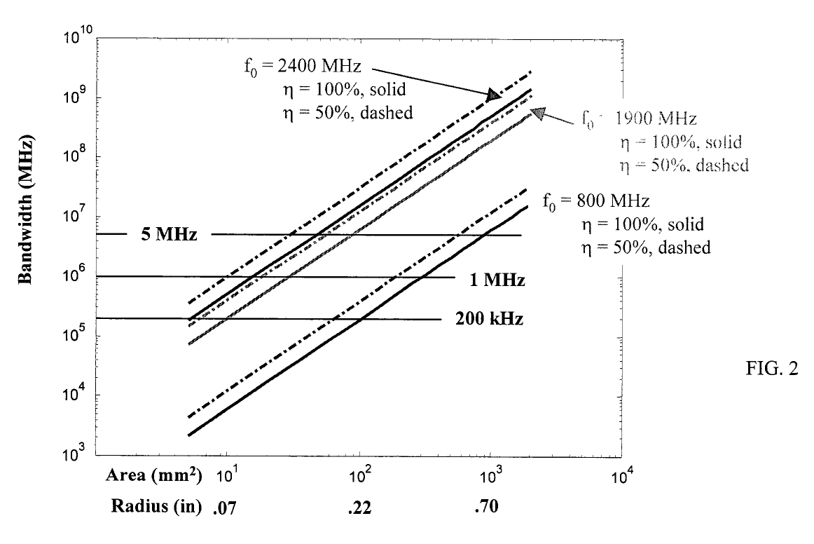

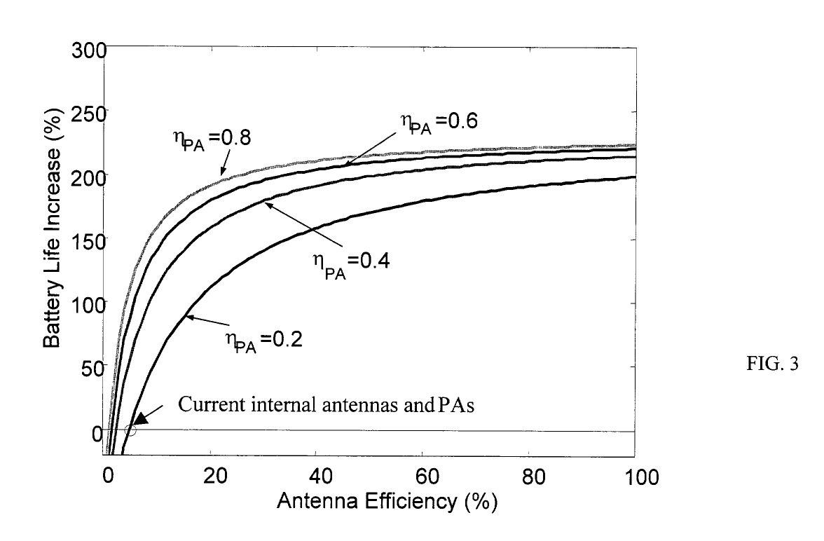

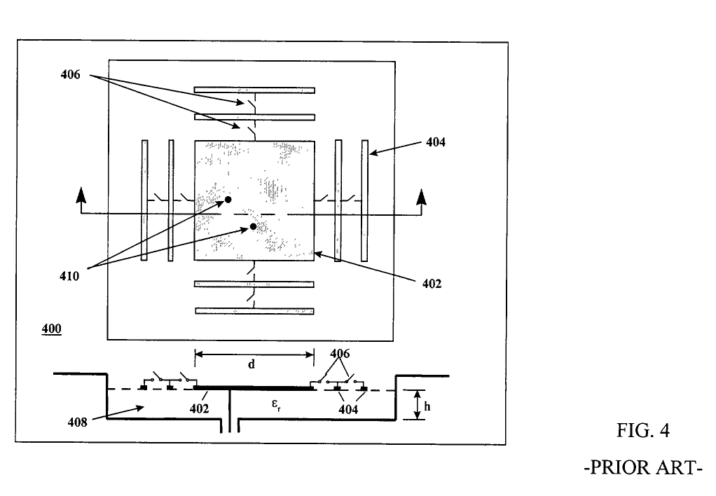

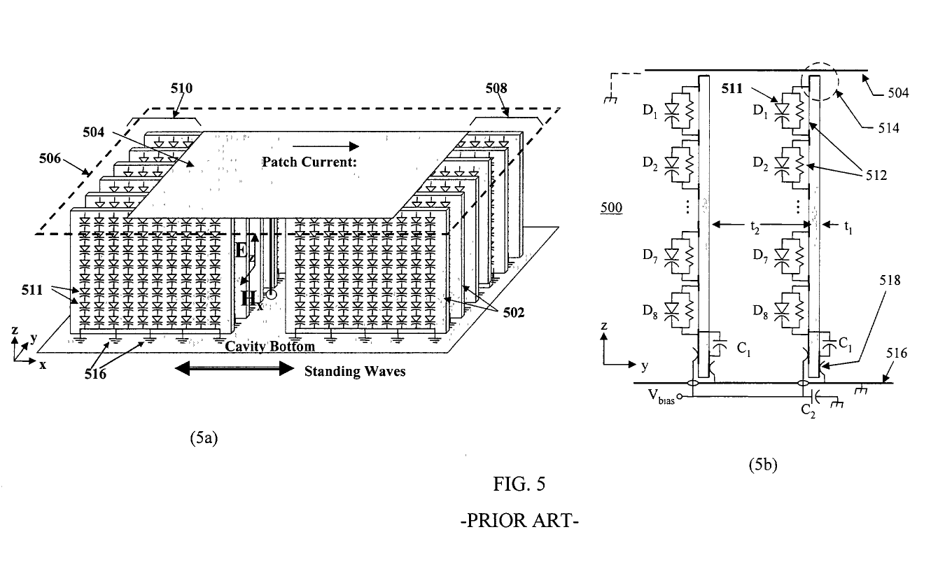

### DETAILED DESCRIPTION OF THE PRESENTLY PREFERRED EMBODIMENTS

In one embodiment, a wireless communication device includes a transmit circuit, a receive circuit and a programmable radio frequency (RF) front end subassembly that is electrically coupled with the transmit circuit and the receive circuit. The programmable RF front end subassembly includes two independently tunable antennas, one or more RF filter sections that are integral to each antenna, and a programmable logic device or antenna control unit (ACU). Each antenna may consist of a planar inverted “F” (PIFA) type structure that is tuned to operate at different frequencies using voltage variable capacitors or RF switches that connect various capacitive loads. Each PIFA is an efficient radiator at a minimum of one frequency, and possibly multiple simultaneous frequencies. In another embodiment, a radio handset with the above-described antenna is integrated with other circuit boards in the manufacturing assembly of a handset or other wireless device. Other embodiments may be developed as well.

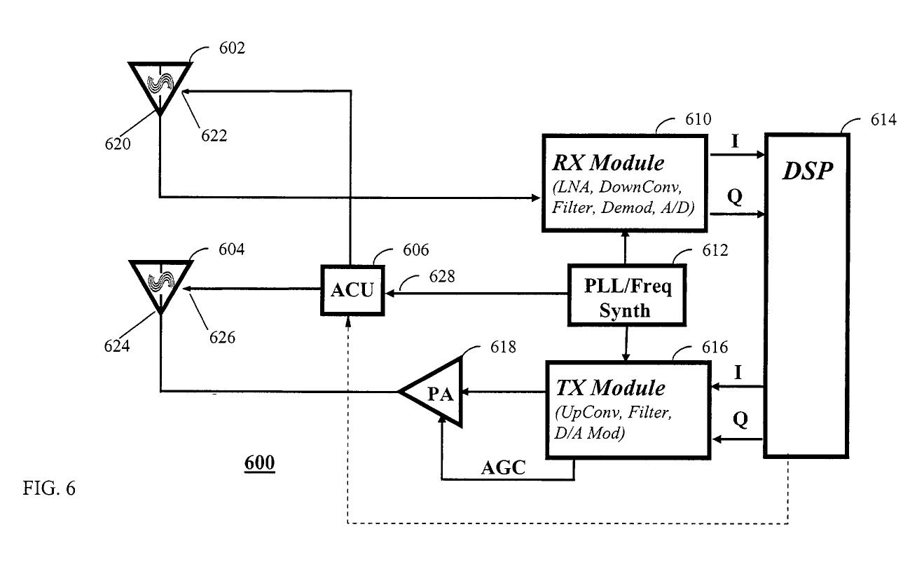

FIG. 6 is a block diagram illustrating the architecture of the radio frequency (RF) portion 600 of a radio. The RF portion 600 includes a receive antenna 602, a transmit antenna 604, an antenna control unit (ACU) 606, a receive module 610, a synthesizer 612, a transmit module 616 and a controller 614.

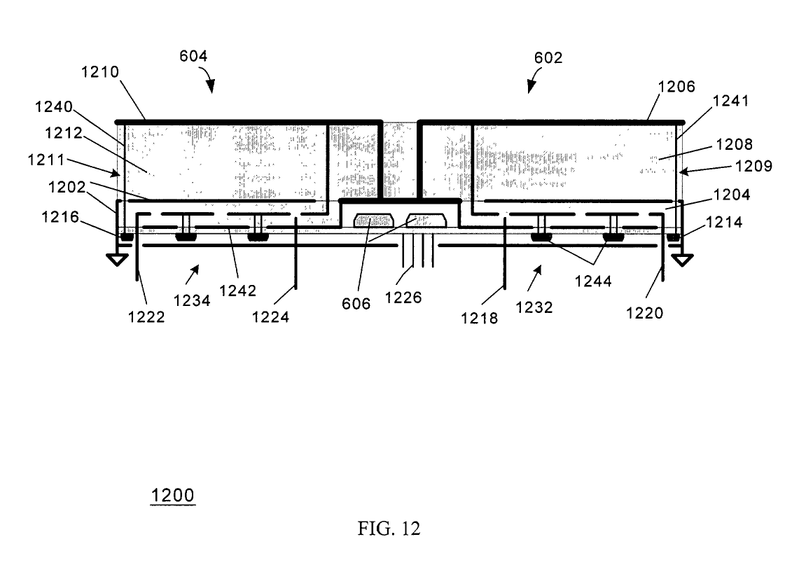

The receive antenna 602 and the transmit antenna 604 are each independently tunable to a selected communication frequency in response to control signals received from the antenna control unit 606. The receive antenna 602 has a feed port 620 coupled with the receive module 610. The receive antenna 602 also has a control port 622 coupled with the ACU 606. The receive antenna detects electromagnetic signals and produces electrical signals at the feed port 620. Operational characteristics of the receive antenna 602 may be varied in response to control signals received at the control port 622. These operational characteristics include at least the resonant frequency of the receive antenna 602, and may also include other characteristics such as the gain bandwidth of the receive antenna 602, input impedance of the receive antenna 602, filter characteristics if filtering functionality is included with the receive antenna 602 and other physical characteristics of the antenna 602. The receive antenna 602 is thus a tunable receive antenna tunable to a receive frequency. Further details about one embodiment of the receive antenna 602 will be provided below in conjunction with FIG. 12.

The transmit antenna 604 has a feed port 624 coupled to the power amplifier 618. The transmit antenna 604 also has a control port 626 coupled with the ACU 606. The transmit antenna 604 receives an antenna feed signal at the feed port 624 and produces radiated electromagnetic energy in response to the feed signal. Operational characteristics of the transmit antenna 604 may be varied in response to control signals received at the control port 626. These operational characteristics include at least the resonant frequency of the transmit antenna 604, and may also include other characteristics such as the gain bandwidth of the transmit antenna 604, input impedance of the transmit antenna 602, filter characteristics if included with the receive antenna 604 and other physical characteristics of the transmit antenna 604. The transmit antenna 604 is thus a tunable transmit antenna. Further details about one embodiment of the transmit antenna 604 will be provided below in conjunction with FIG. 12.

The receive antenna 602 and the transmit antenna 604 may be embodied using any of the prior art programmable or reconfigurable antennas described above. In the preferred embodiment, the antennas 602, 604 are embodied as a planar inverted F antenna (PIFA). Separate transmit and receive antennas are also preferred since this allows optimization of impedance matching between the receive antenna 602 and the low noise amplifier of the receive module 610 and between the power amplifier 618 and the transmit antenna 604. Also, separate antennas are preferred for elimination of a transmit/receive switch or diplexer required in single antenna embodiments.

Further, the receive antenna 602 and the transmit antenna 604 are preferably independently tunable to a receive frequency and a transmit frequency, respectively. This feature provides maximum radiation efficiency for a given physical size of the antenna by limiting the instantaneous bandwidth of the antenna. Further, this feature allows coverage of a larger frequency range than is achievable from a non-tuned antenna of the same size and performance.

The ACU 606 is coupled with the transmit antenna 604 and the receive antenna 602 and is configured to control operation of the transmit and receive antennas 602, 604. In this embodiment, controlling operation includes at least tuning one or both of the transmit and receive antennas. Tuning in this context means selecting one or more resonant frequencies or bands of frequencies for the transmit and receive antennas. In other embodiments, controlling may include varying bandwidth and other performance parameters. The ACU 606 receives frequency, timing, and possibly other control signals at an input 628 from the synthesizer 612, or from the controller 614 as indicated by the dashed line in the drawing figure. The timing signal controls timing of the ACU 606.

In the illustrated embodiment, the ACU 606 is embodied as a programmable logic device (PLD), an application-specific integrated circuit the functionality of which has been customized for the operation of the ACU 606. A PLD provides advantages of small size, light weight and low power dissipation, along with high levels of integration of digital logic blocks necessary to perform the requisite functions. In other embodiments, the ACU 606 may be embodied as a general purpose processor programmed according to data and instructions stored in an associated memory device. In still other embodiments, the functionality of the ACU 606 may be integrated into the controller 614 in direct control of the receive antenna 602 and the transmit antenna 606. Such an integration may be realized by designing a custom baseband chipset for the radio.

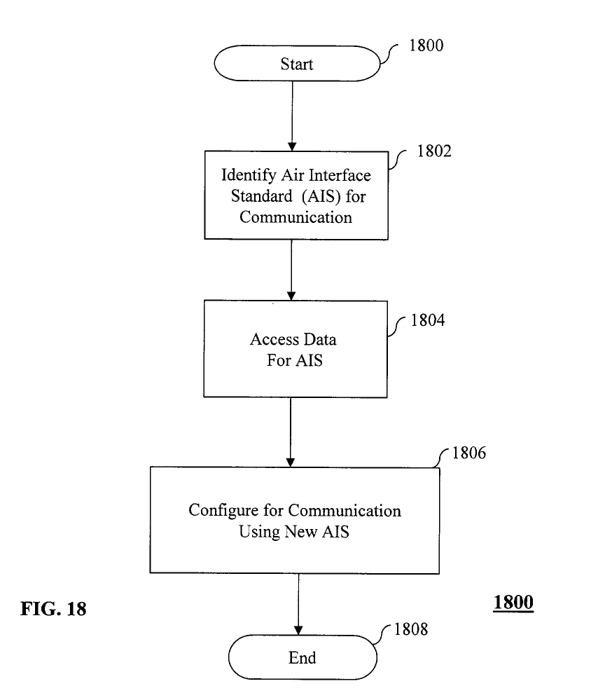

In one embodiment, the radio including the ACU 606 can download control information from memory or over the air to program the ACU 606. The ACU establishes operational parameters for the RF portion 600 of the radio. These operational parameters are controlled in one embodiment by writing appropriate data and/or instructions to the ACU 606. The source of this data may be any suitable data source. For example, it is envisioned that that radio may be configured or reconfigured on the fly, by updating configuration data at the ACU in response to a changing radio environment. In one example, the radio may be operating under a GSM/DCS air interface standard at DCS frequencies, with transmit and receive bands in the vicinity of 1900 MHz. As the portable radio moves to a new location, the air interface standard may change dynamically. For example, a Bluetooth transmission at 2400 MHz may be required. This information may be transferred to the radio in any suitable manner. Further, the configuration data necessary to re-configure the radio may be provided to the ACU 606 in any suitable manner. This is illustrated in further detail in connection with FIG. 18.

Preferably, the antennas 602, 604 are controlled from a single programmable control unit such as the ACU 606. This allows autonomous control and validation of RF hardware configuration by other portions of the radio including the RF portion 600, such as the DSP or controller 614. Further, this feature may be combined with functionality of a software-defined radio. All software-defined characteristics of the radio may be established or updated at a common time.

In one embodiment, the ACU 606 receives digital information concerning the transmit and receive frequencies, as well as a timing signal or strobe signal indicating when the antennas are to be tuned to a new frequency. The frequency information may arrive as separate digital words for transmit and receive frequencies, or it may arrive as one of these frequencies, plus the offset between transmit and receive frequencies. The digital bus between the ACU 606 and the controller 614 may be a parallel bus, but the preferred embodiment is a serial data bus. In this embodiment, the ACU 606 outputs two analog tuning voltages, one to each of the independently tunable antennas 602 and 604. Also, the ACU 606 provides one or more filter control signals to tune the one or more RF filters associated with antennas 602 and 604. Such filter control signals may control RF switches, variable capacitance elements, or a combination of both.

In a further embodiment, the ACU 606 provides the above functions in addition to both coarse and fine tuning features. For instance, the ACU may provide analog control signals to actuate RF switches which provide course or large frequency shifts, while the ACU also provides analog voltages to bias variable capacitance elements for fine or small frequency adjustments.

The receive module 610 generally includes a low noise amplifier (LNA) and provides frequency down-conversion, filtering, demodulation, analog to digital conversion, etc., as indicated in FIG. 6. The transmit module 616 generally provides frequency up-conversion, filtering, digital to analog conversion and modulation as indicated in FIG. 6. The synthesizer 612 generates signals at appropriate frequencies for mixing with other signals for upconversion or downconversion.

The power amplifier 618 amplifies RF signals from the transmit module 616 to a power level sufficient to drive the transmit antenna 604. Any conventional power amplifier may be used. The power amplifier 618 need not be modified to accommodate the tunable transmit antenna 604. Preferably, the transmit antenna 604 in conjunction with the antenna control unit 606 is programmable to accommodate particular characteristics of the power amplifier 618, such as low output impedance.

The controller 614 controls operation of the RF portion 600. In the illustrated embodiment, the controller 614 is embodied as a digital signal processor (DSP) and operates in conjunction with data and instructions stored in memory. The memory may be integrated with the DSP or may be packaged separately. In other embodiments, the controller 614 may be embodied as a general purpose processor such as a microprocessor or microcontroller. In still other embodiments, the functionality of the controller 614 may be partitioned among many devices and software routines of the radio including the RF portion 600.

In the preferred embodiment, the controller 614 controls other operations of the radio which includes the RF portion 600. For example, the functions of the controller 614 may be provided by the call processor of a radiotelephone handset, which is also responsible for timing operations and controlling the user interface of the radiotelephone. In some embodiments, however, the controller 614 may be dedicated to controlling the RF front end of the radio, including functions such as modulation, demodulation, encoding and decoding. In a software definable radio, where the radio hardware is fixed but may be customized by on-board software during operation to allow the radio to operate in conjunction with a particular air interface standard or on a particular frequency band, the customization operation may be controlled by the controller 614.

The RF system block diagram in FIG. 6 addresses the RF section 600 as defined above and provides an integrated and cost effective solution for accommodating multiple air interface standards that can be downloaded on the fly into the baseband section of software defined radios, to be described below in conjunction with FIG. 18. This evolution will require changes in system architecture, more comprehensive use of new semiconductor processes such as RF complementary metal-oxide-semiconductor (CMOS), gallium arsenide (GaAs) heterojunction bipolar transistors (HBT) and silicon-germanium (SiGe) and utilization of new technologies such as RF micro-electromechanical system (MEMS) switches. The separate transmit and receive antennas 604, 602 are reconfigurable in frequency, selectivity, efficiency, input impedance and bandwidth. The programmable antenna control unit 606 receives information from either the frequency synthesizer 612 or the DSP 614 and controls the antenna resonant frequency and filter configuration. This architecture provides a very clean functionality that does not require separate dedicated hardware paths to accommodate new air interface standards.

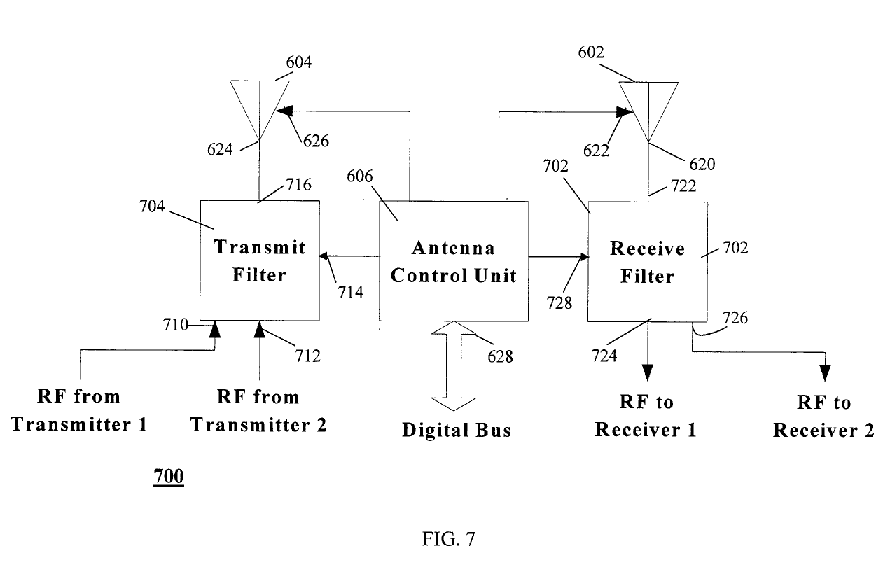

FIG. 7 is a block diagram showing another embodiment of a programmable RF portion 700 of a radio. The RF portion 700 includes a receive antenna 602, a transmit antenna 604 and an antenna control unit 606. The RF portion 700 further includes a receive filter 702 and a transmit filter 704.

The transmit filter 704 has a first RF input 710 coupled to a first transmitter (not shown) of the radio and a second RF input 712 coupled to a second transmitter (not shown). The transmit filter 704 further has a control input 714 coupled to the antenna control unit (ACU) 606 to receive a control signal and an output 716. By means of the control input 714, the transmit filter 704 receives control signals from the ACU 606 which control the transmit filter 704. In this context, controlling the transmit filter 704 includes selecting or multiplexing the RF signal among two source transmitters. Controlling also includes providing control signals to the transmit filter 704 to define the filter characteristics. The transmit filter 704 may be an analog filter or any suitable type of filter providing the necessary transfer function. The control signal thus may include digital data to vary the digital filter response or bias signals to vary performance of devices such as voltage variable capacitance elements. The output signal from the transmit filter 704 at the output 716 drives the transmit antenna 604.

The receive filter 702 has an input 722 coupled to the receive antenna 602, a first output 724 coupled to a first receiver, a second output 726 coupled to a second receiver, and a control input 728. The receive filter 702 receives a detected RF signal at the input 722, filters the signal and provides the filtered signal at one or both outputs 724, 726. The receive filter 702 receives a control signal at the control input 728. The control signal controls operation of the receive filter 702. In this context, controlling the receive filter 702 includes selecting or multiplexing the RF signal among two or more destination receivers. Controlling also includes providing control signals to the receive filter 702 to define filter characteristics such as center frequency, bandwidth, group delay, etc. The receive filter 702 may be a digitally-controlled filter, an analog-controlled filter, or any suitable type of filter providing the necessary transfer function. The control signal thus may include digital data to vary the digital filter response or bias signals to vary performance of devices such as voltage variable capacitance elements.

In the embodiment of FIG. 7, the ACU 606 receives control signals over a digital bus at control input 628. The control signals are provided from other control circuitry of the radio including the RF portion 700. The control signals may include digital data words as well as analog bias signals for controlling the ACU 606.

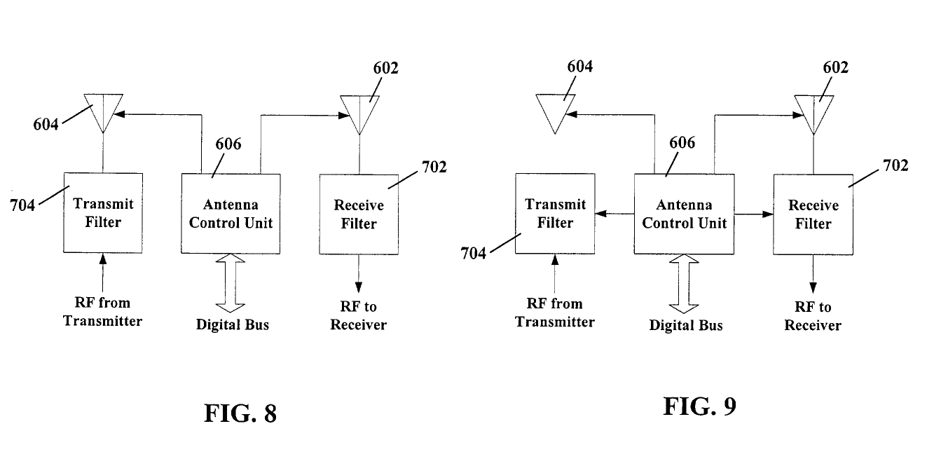

FIGS. 8 and 9 are a block diagrams illustrating alternative embodiments of an RF system architecture of a programmable radio. The embodiment of FIG. 8 shows a tunable RF front end in which only the receive antenna 602 and the transmit antenna 604 are tunable. The filters, receive filter 702 and transmit filter are fixed. That is, the passband of the receive and transmit filters 702, 704 is not variable but is set by device values or other means. The receive antenna 602 and the transmit antenna 604 each receive control signals from the antenna control unit 606 to control the frequency or band of frequencies to which the respective antenna 602, 604 is tuned. Other electrical or performance parameters of the antennas may be controlled as well by the control signals.

In the embodiment of FIG. 9, the receive antenna 602 and the transmit antenna 604 are tunable. Also, the receive filter 702 and the transmit filter 704 are tunable. The filters 702, 704 each receive a control signal from the antenna control unit 606. In response to this control signal, the resonant frequency, bandwidth or other aspects of the filter response may be varied. Control signals are also supplied to the receive antenna 602 and the transmit antenna 604 to tune the antennas 602, 604, as well.

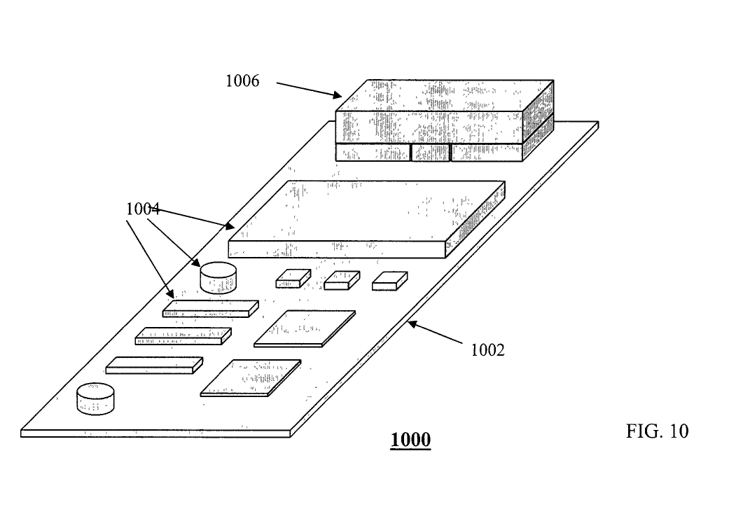

FIG. 10 is a perspective view showing integration of a programmable RF front end with other components of a wireless communication device 1000 such as a radio handset. In FIG. 10, the wireless communication device 1000 includes a printed circuit board (PCB) 1002 and components mounted on the PCB 1002, including electronic components 1004 and a programmable RF front end assembly 1006. For forming a complete wireless communication device such as a radio handset, the wireless communication device 1000 would generally include a housing containing a battery, the PCB 1002 and an additional printed circuit board implementing other functions such as user interface functions.

The programmable RF front end assembly 1006 is mounted on one surface of the PCB 1002. Alternatively, through-hole mounting techniques may be used but surface mounting may be preferable for the reduced size and improved electrical properties it provides. Structure of the programmable RF front end assembly 1006 will be discussed in greater detail below. Other electronic components 1004 are also mounted on the surface of the PCB 1002. These components include a controller such as a digital signal processor or other processor, memory devices, analog circuits such as voltage regulators, etc. The PCB 1002 includes embedded signal lines which convey control and data signals among the programmable RF front end assembly 1006 and the other components 1004.

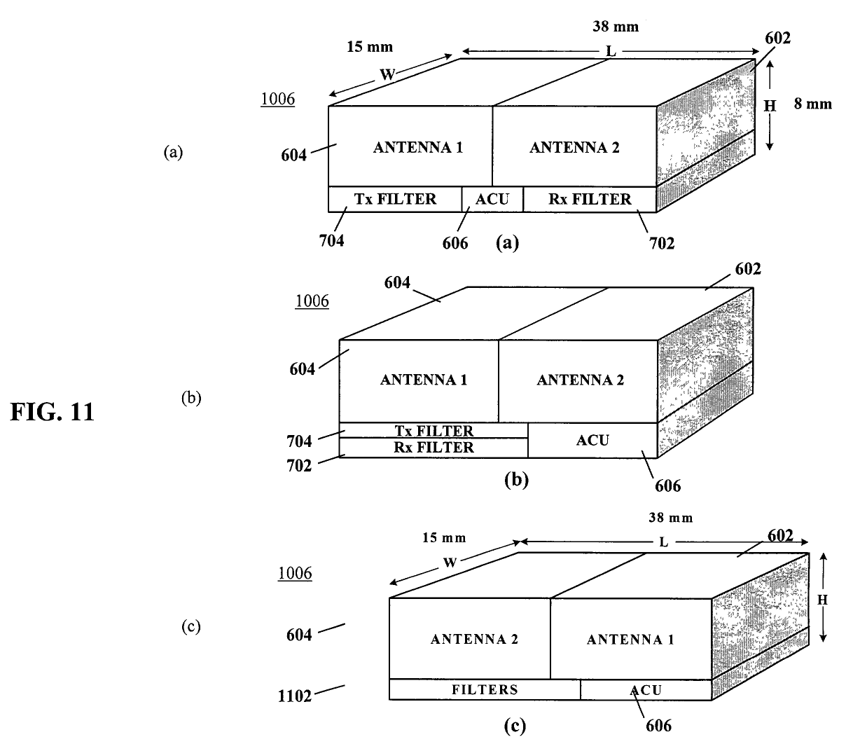

FIG. 11 shows perspective views of three embodiments of a programmable RF front end component 1006 for use with the wireless communications device of FIG. 10. Exemplary dimensions are shown in FIG. 11(a) and FIG. 11(c). These exemplary dimensions suggest that the programmable RF front end assembly 1006 may be readily integrated in even the smallest radiotelephone handsets. Further details regarding construction of a programmable RF front end assembly such as that shown in FIG. 11 will be provided below in conjunction with FIG. 12.

In the embodiment of FIG. 11(a), the programmable antennas 602, 604 are placed side by side. The programmable filters 702, 704 are generally coplanar and formed on an adjacent plane along with the antenna control unit (ACU) 606. This embodiment is particularly useful in embodiments in which both antennas 602, 604 and both filters 702, 704 are tunable or programmable, since the ACU 606 is centrally located, simplifying routing of control signals from the ACU 606 to the antennas 602, 604 and the filters 702, 704. The embodiment of FIG. 11(b) provides similar benefits. The embodiment of FIG. 11(c) may be particularly useful if the filters 702, 704 are not programmable or tunable. In that embodiment, the filters 702, 704 are positioned between the antennas 602, 604 and contacts to a printed circuit board on which the programmable RF front end component 1006 is mounted.

The embodiments of FIG. 11 are illustrative only. Many other embodiments can be developed and may be implemented to satisfy particular design goals and requirements of a radio including the programmable RF front end component 1006. In some other embodiments, the antennas, filters and control unit may be separated rather than integrated, or only some of these devices may be integrated in a single assembly.

FIG. 12 is an elevation view of one embodiment of the programmable RF front end 1200. The programmable RF front end 1200 corresponds to the programmable RF front end assembly 1006 of FIG. 10. In the illustrated embodiment, the programmable RF front end 1200 includes two antenna structures, two filter sections and an antenna control unit.

The programmable RF front end 1200 includes a receive antenna 602, a transmit antenna 604 and an antenna control unit (ACU) 606. The programmable RF front end 1200 further includes a ground plane 1202 and a stripline feed distribution layer 1204.

The antennas 602, 604 in the illustrated embodiment are two adjacent planar inverted F antennas (PIFAs). The receive antenna 602 includes a receive PIFA 1206. The transmit antenna 604 includes transmit PIFA 1210 which has an aperture 1211. For tuning, the receive antenna includes one or more voltage-variable capacitive elements 1214 and the transmit antenna includes one or more voltage-variable capacitive elements 1216. In one embodiment, the capacitive elements are varactor diodes but other voltage variable devices such as radio frequency micro-electromechanical systems (RF MEMS) variable capacitors may be substituted.

The ground plane 1202 forms a common ground plane for the transmit and receive PIFA antennas 1210 and 1206. This ground plane 1202 also forms the upper ground plane for a stripline feed distribution layer 1204. This layer 1204 is used to implement transmit and receive filter functions 702 and 704 in FIG. 7.

The capacitive elements 1214, 1216, such as RF MEMS or solid state varactors, form tuning components. They are effectively placed in the aperture 1209, 1211 of each PIFA 1206, 1210 by virtue of vias 1240 and 1241 which allow the reactance of the tuning devices to load the apertures. The capacitive elements 1214, 1216 are used to independently adjust the resonant frequency of each PIFA 1206, 1210. The capacitive elements reduce the PIFA length and, when the aperture capacitance is tuned, allow it to operate at low frequencies where the PIFA structure is much less in length than one quarter of a free space wavelength. Each PIFA has a single coaxial feed near the back shorting wall or ground plane 1202 that is connected to a stripline feed distribution layer 1204.

In the illustrated embodiment, the feed distribution layer 1204 includes RF filter sections. These include a receive filter 1232 and a transmit filter 1234. The filters 1232, 1234 in some embodiments may be tunable using RF solid state or MEMs switches or varactor diodes or other suitable elements. The control signals for tuning or otherwise varying the filter characteristics of the filters 1232, 1234 may be routed in or below the feed distribution layer 1204. In one embodiment, the filter control signals and ACU signals are routed across printed traces of a low permittivity (∈ᵣ˜2 to 6) dielectric layer 1242. Layer 1242 is attached to the lower ground plane of the stripline feed distribution layer 1204. Variable capacitance elements 1244 and ACU components 806 are surface mounted on one or both sides of layer 1242. In this one embodiment, all of the electronic components in the programmable RF front end are surface mounted to layer 1242.

The filters 1232,1234 may be embodied as any suitable filter providing the necessary filtering characteristics. In one embodiment, the filters 1232, 1234 comprise bandpass filters formed using stripline technology. The individual resonator types can be hairpin-comb resonators, split ring resonators, or variations thereof. Exemplary embodiments are shown in the following references:

Yabuki et. al. “Hairpin-Shaped Stripline Split-Ring Resonators and Their Applications,” Denshi Joho Tsushin Gkkai Ronbunshi, Vol. 75-C-I, No. 11 pp. 711-720. (No. 1992);

Matthaei et. al. “Narrow-Band Hairpin-Comb Filters for HTS and Other Applications,” IEEE Transactions on Microwave Theory and Techniques, 1996, pp. 457-460;

P. Pramanick, “Compact 900 MHz Hairpin-Line Filters Using High Dielectric Constant Microstrip Line,” Intl. Journ. Of Microwave and Millimeter-Wave Computer-Aided Engineering, Vol. 4, No. 3, pp. 272-281, 1994; and

Yabuki et. al. “Plane Type Strip Line Filter in which Strip Line is Shortened and Dual Mode Resonator in which Two Types Microwaves are Independently Resonated,” U.S. Pat. No. 6,121,861. Issued Sep. 19, 2000.

The programmable RF front end 1200 may be embodied using a high permittivity ceramic dielectric, typically ∈ᵣ=24 to 40, to reduce the physical dimensions of the stripline resonators. However, the PIFAs need a medium-to-low permittivity substrate, of ∈ᵣ=10 or less. One possible choice of manufacturing technology for the programmable RF front end 1200 is low temperature co-fired ceramic (LTCC). Using LTCC in one presently preferred embodiment, the programmable RF front end 1200 can be formed as a single fired ceramic assembly that has multiple dielectric and metal layers in which the dielectric layers may have a wide range of low loss dielectric constants. The programmable RF front end 1200 can be fabricated entirely from LTCC and the semiconductor devices and/or MEMS devices can be added subsequently.

Each feed has one or two outputs for receive and transmit. In the illustrated embodiment, the receive antenna has a first receive antenna port 1218 and a second receive antenna port 1220. The transmit antenna has a first transmit antenna port 1222 and a second transmit antenna port 1224. The programmable RF front end 1200 includes a connector 1226 for electrically coupling and mechanically mounting the programmable RF front end 1200 on a printed circuit board or other device. In this embodiment, connector 1226 is used to route digital or analog control signals to the ACU 606.

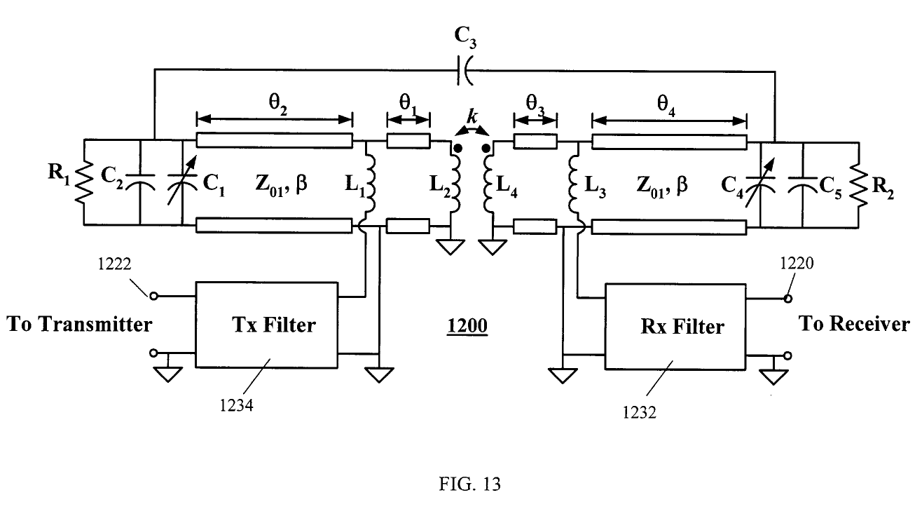

FIG. 13 shows an equivalent circuit shown for the programmable RF front end 1200 of FIG. 12. This equivalent circuit further serves to explain the electromagnetic operation of the tunable antennas. The following nomenclature is used:

θ_{2,4}=length of transmission line consisting of bottom and top plates of a PIFA whose length is the distance between the probe conductor and the PIFA aperture.

θ1,3=length of transmission line consisting of bottom and top plates of PIFA whose length is the distance between the probe conductor and the PIFA back wall.

Z₀₁=characteristic impedance of PIFA transmission line sections

β=phase constant of PIFA transmission line sections

L_{1,3}=probe self inductance of feed

L_{2,4}=loop inductance of PIFA back wall current path

k=coupling coefficient between the two back wall loops

C_{1,4}=tuning capacitance placed in the PIFA aperture

C_{2,5}=PIFA external aperture capacitance (susceptance)

R_{1,2}=PIFA external aperture radiation resistance (conductance)

C₃=mutual coupling capacitance between the two PIFA apertures

In the equivalent circuit of FIG. 12, signals that are transmitted from the radio primarily deliver power to the radiation resistance R₁. Capacitor C₁ is varied electronically to achieve maximum power transfer at the desired frequency. Some of the transmit energy is coupled to the receive circuit via inductive and capacitive coupling mechanisms denoted as k and C₃. The PIFA structure is designed to minimize this coupling, which is naturally small because the transmit and receive bands are offset in frequency. Typical levels of mutual coupling are −15 to −25 dB. On reception, capacitor C₄ is tuned to receive maximum power from an equivalent source across the radiation resistance R₂. Filters are further used in both the transmit and receive paths to obtain the desired spectral response and out-of-band rejection.

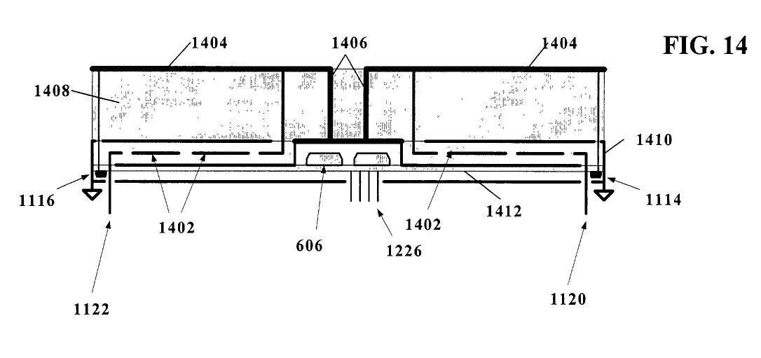

FIG. 14 is an elevation view of a second embodiment of a programmable RF front end 1006. In the embodiment of FIG. 14, the device includes integrated, fixed frequency RF filters. Filter resonators 1402 are positioned between the transmit port 1122 and the transmit antenna feed and between the receive port 1120 and the receive antenna feed. The receive and transmit antennas are planar inverted F antennas (PIFAs) including a PIFA lid 1404 and a PIFA short 1406. In general, the antenna structure 1408 adjacent the lid 1404 is constructed from a low loss, low ∈ᵣ dielectric. The antenna structure 1410 containing the filter resonators 1402 is formed from a low loss and high ∈ᵣ dielectric material. The ACU electronics 606 are mounted on a low cost printed circuit board 1412.

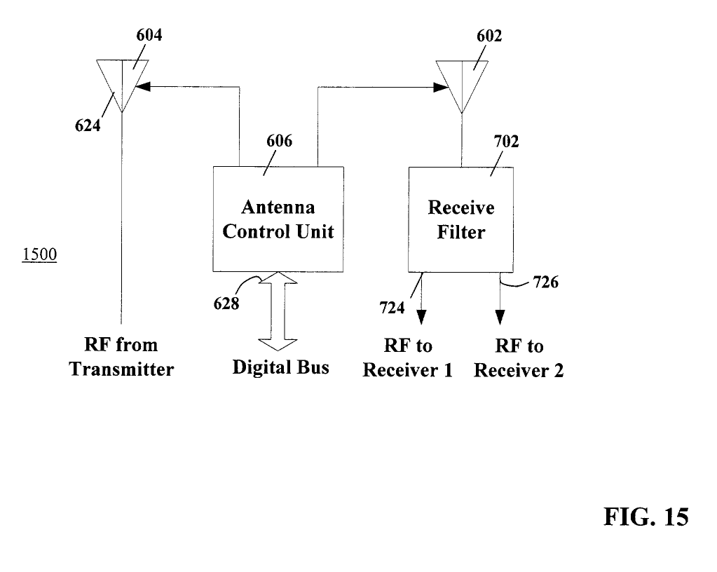

FIG. 15 is a block diagram of an alternative embodiment of a an RF system 1500 of a programmable radio. In the embodiment of FIG. 15, the RF system 1500 includes a tunable receive antenna 602, a tunable transmit antenna 604, a receive-only diplexing filter 702 and an antenna control unit 606. The RF system 1500 omits a transmit filter, which may instead be included with the transmitter, not shown in FIG. 15. The receive filter 702 has a first output 724 which is configured to be coupled to a first receiver of a radio incorporating the RF system 1500. The receive filter 702 further includes a second output 726 which is configured to be coupled to a second receiver of the radio. The receive filter selects the signals to be provided to each receiver according to, for example, frequency of the signals. The antenna control unit 606 provides control signals to the receive antenna 602 and the transmit antenna 604 to control the tuning or other electrical properties of the antennas 602, 604.

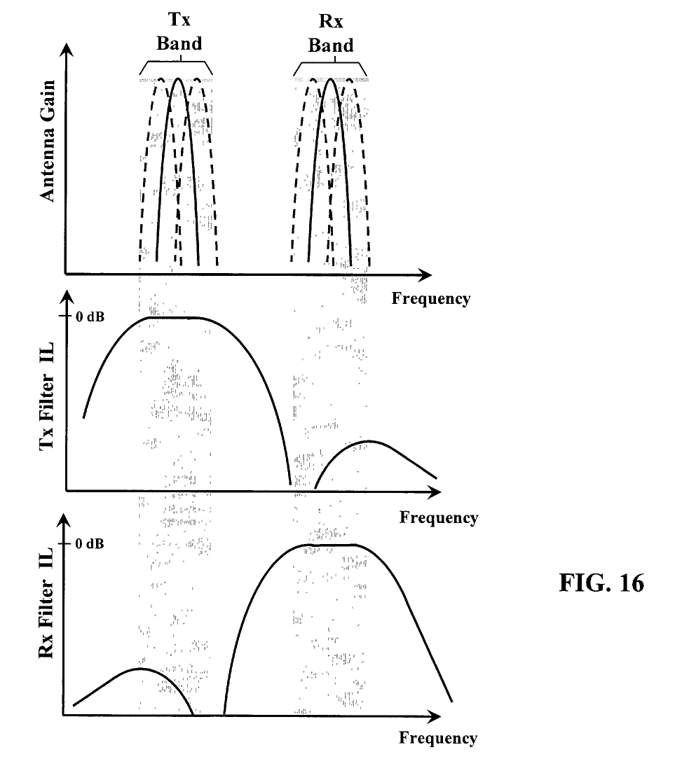

FIG. 16 illustrates frequency response curves for an antenna, transmit filter and receive filter in a radio. As is indicated by the antenna curves, the system on which the radio operates defines a transmit band of frequencies or channels for transmission of radio signals from the radio to a remote radio, as well as a receive band of frequencies or channels for reception of radio signals from remote radios at the radio. Each channel is relatively narrow band and the receive and transmit band may each have hundreds of channels. Channel bandwidth and spacing are defined by the air interface standard for the system.

For operation in the system, the transmit filter preferably has a frequency response curve similar to that shown in the middle portion of FIG. 16. Signals within the transmit band are filtered with essentially no gain. Signals at frequencies outside the transmit band are suppressed or filtered. In particular, frequencies in the receive band of the radio are strongly filtered to prevent reception at the radio of its own transmitted signals.

Similarly, for operation in the system, the receive filter preferably has a frequency response curve similar to that shown in the lower portion of FIG. 16. Signals in the transmit band and otherwise outside the receive band are largely suppressed or filtered. Signals in the receive band are passed with little or no attenuation.

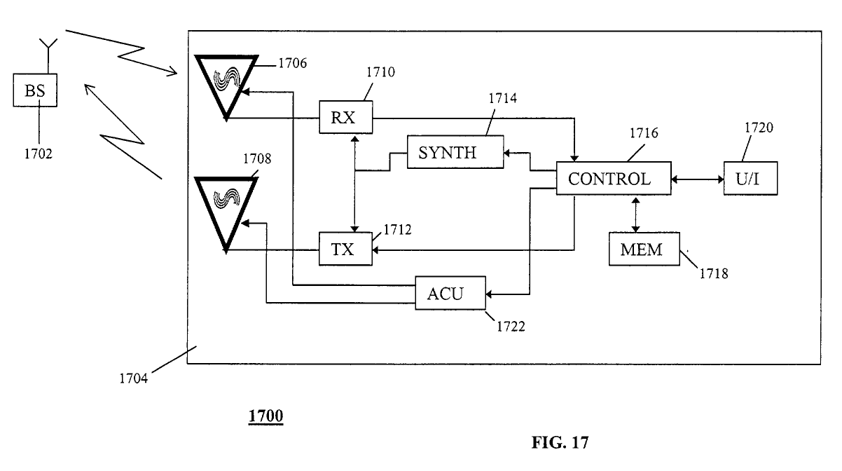

FIG. 17 is a block diagram illustrating a radio communication system 1700 including a fixed or base station 1702 and a mobile or portable handset or radiotelephone 1704. In one embodiment, the radio communication system 1700 is a cellular or PCS radio communication system in which the base station 1702 provides two-way radio communication to mobile stations such as the radiotelephone 1704 in a geographic region near the base station 1702. The radiotelephone 1704 may be embodied in a design similar to that shown in FIG. 10. In the illustrated embodiment, the radiotelephone 1704 is embodied as a portable radio providing two-way voice and data communications. In other applications, the radiotelephone 1704 may be embodied as a fixed radio, as a trunked radio or as a two-way radio communicating data, such as a pager.

The radiotelephone 1704 includes a receive antenna 1706, a transmit antenna 1708, a receive circuit 1710 and a transmit circuit 1712. The radiotelephone 1704 further includes a synthesizer 1714, a control circuit 1716, a memory 1718, a user interface 1720 and an antenna control circuit 1722.

The receive antenna 1706 and the transmit antenna 1708 may be implemented as described above in connection with FIGS. 8-12. In particular, each of the receive antenna 1706 and the transmit antenna 1708 is a tunable antenna which has a resonant frequency that varies in response to a control signal received from the antenna control circuit 1722. The control signal may include digital data or commands, analog signals such as bias voltage for voltage-controlled capacitive elements of the receive antenna 1706 and the transmit antenna 1708, or a combination of these. Further, one or both of the receive antenna 1706 and the transmit antenna 1708 may include a filtering function. For example, the receive antenna 1706 and the transmit antenna 1708 may be integrated as shown above along with a transmit filter and a receive filter. Such an embodiment reduces the size, weight and parts count of the radiotelephone. Further, such an embodiment allows the RF front end of the radiotelephone 1704 to be software programmable along with other components of the radiotelephone for adaptation to any suitable air interface standard.

The receive circuit 1710 receives electrical signals from the receive antenna 1706. The receive circuit 1710 generally includes a low noise amplifier, demodulator and decoder. The receive circuit 1710 demodulates and decodes the data contained in the received signals and conveys this data to the control circuit 1716.

Preferably, the receive circuit 1710 is software programmable, meaning that the functionality of the receive circuit may be tailored for a specific air interface standard in response to data and instructions provided to the receive circuit. Air interface standards control the communication of information between two or more radios such as the base station 1702 and the radiotelephone 1704. Air interface standards define factors such as radio frequencies for communication, channel bandwidth, modulation technique, and so forth. Examples of air interface standards include GSM, CDMA, TDMA, W-CDMA, etc. Alternatively, published examples of air interface standards include Advanced Mobile Phone Service (AMPS); North American Digital Cellular service according to J-STD-009; PCS IS-136 Based Mobile Station Minimum Performance 1900 MHz Standard and J-STD-010 PCS IS-136 Based Base Station Minimum Performance 1900 MHz Standard (“IS-136”); Code Division Multiple Access (CDMA) radiotelephone service according to EIA/TIA interim standard 95 Mobile Station-Base Station Compatibility Standard for Dual-Mode Wideband Spread Spectrum Cellular System (“IS-95”); Global System for Mobile Communication (“GSM”); and satellite protocols such as that proposed by Iridium, L.L.C. Portions of these and other standards may also be considered to be air interface standards.

The control circuit 1716 controls operation of the radiotelephone 1704. The control circuit 1716 may be implemented as a digital signal processor, microprocessor, microcontroller or as discrete logic implementing the necessary functions to control the radiotelephone 1704. The memory 1718 stores data and instructions for use by the control circuit 1716. For example, the memory may store information about channel frequency assignments, etc., for use by the software programmable radiotelephone 1704. In response to information about an active air interface standard, the control circuit 1716 accesses this data in the memory 1718 and uses the data to control the transmit circuit 1712, the receive circuit 1710, the synthesizer 1714 and the antenna control unit 1722. Other components of the radio may access data in the memory over a system bus or other communication means.

The user interface 1720 allows user control of the radiotelephone 1704. In a typical embodiment, the user interface 1720 includes a display, a keypad, a microphone and a speaker.

The transmit circuit 1712 receives data from the control circuit 1714 and in response, applies time varying electrical signals to the transmit antenna 1708. Preferably, the transmit circuit 1712 is software programmable, meaning that the functionality of the transmit circuit 1712 may be tailored for a specific air interface standard in response to data and instructions provided to the transmit circuit.

The synthesizer 1714 produces high-precision, time varying signals for use by the receive circuit 1710 and the transmit circuit 1712. The synthesizer 1714 operates under control of the control circuit 1716 to produce the required frequency. For example, the radiotelephone 1704 may be tuned to a transmit frequency and a receive frequency for duplex operation. The synthesizer 1714 provides to the receive circuit 1710 and the transmit circuit 1712 the time varying signals necessary to receive and transmit on the assigned frequencies.

The radiotelephone in accordance with the present embodiments may be operated on any suitable radio communication system. The radio may support any type of carrier modulation such as frequency modulation (FM), gaussian phase shift keying (GPSK), gaussian mean shift keying (GMSK), quadraduture amplitude modulation (QAM) or other scheme now know or later developed. Further the radio may support any type of multiple access technique such as frequency division multiple access (FDMA), time division multiple access (TDMA), code division multiple access (CDMA), wideband code division multiple access (W-CDMA), or combinations of these. Accommodating these modulation schemes and multiple access schemes may be accomplished by selecting appropriate receiver circuits and transmitter circuits and through appropriate software programming of the control circuit of the radio.

FIG. 18 is a flow diagram illustrated a method for operating a radio such as the radiotelephone 1704 of FIG. 17. The illustrated method is useful for software-programming a radio such as radiotelephone 1704 for operation in accordance with an air interface standard (AIS). The method begins at block 1800.

At block 1802, an air interface standard is identified for wireless communication. If the radio is currently in radio communication, the AIS may be identified by receiving radio signals defining the AIS. For example, the remote radio or base station with which the radio currently communicates may send control transmissions including data identifying a new AIS or new characteristics of an AIS for use by the radio. In one example, a base station may instruct the radio to move to a different frequency band, specifying the new frequencies for communication and timing information for synchronization using the same type of modulation and multiple access. In another example, the base station may specify a completely different air interface standard than is currently in use, such as a switch from CDMA at 800 MHz to GSM at 1900 MHz.

In other embodiments, identification of the air interface standard may be achieved by manual entry or wireline entry of this information. Alternatively, the identification may be made by some automatic procedure such as lapse of a timer or satisfaction of some logical query. In alternative embodiments, the identification process may be omitted if the AIS is previously known.

At block 1804, configuration data associated with the identified AIS is accessed. Information specifying a change to the current configuration or a new AIS is configuration data. In one embodiment, the configuration data is access by retrieving data from a storage device of the radio as the configuration data. This may be done in response to an indication, command or control data received over a radio link. For example, a control channel received at the radio may designate as the AIS W_CDMA at 800 MHz. In response to this information, the radio may retrieve from its on-board memory the data associated with this AIS, such as frequency of operation, modulation and demodulation method, encoding and decoding method and filter settings.

In another embodiment, data in radio signals received at the radio may be detected as the configuration data. In this example, the information about the frequency of operation, modulation method, encoding method and filter settings (or other information) may be transmitted to the radio over the radio channel. This embodiment increases traffic in a radio system but reduces the storage requirements for the radio.

In another embodiment, the configuration data may be accessed by producing the data in response to air interface identification information received at the radio. For example, to reduce traffic in the system and to reduce storage requirements, the configuration data may be compressed or encoded into a format not directly usable. A reverse compression or decryption process is required to produce the configuration data.

At block 1806, the radio is configured for communication according to the identified AIS. This is done in response to or using the configuration data. For example, if the configuration specifies a frequency for communication, configuring the radio for communication involves tuning at least one of a first antenna, such as the receive antenna 1706, FIG. 17, and a second antenna, such as the transmit antenna 1708, to a communication frequency associated with the air interface standard. The precise frequency or band of frequencies may be specified by the configuration data or may be determined in some manner from the configuration data. In another example, configuring the radio includes matching the impedance of a low noise amplifier of the radio with the impedance of the tunable receive antenna and matching impedance of a power amplifier of the radio with the impedance of the transmit antenna.

In an alternative embodiment, the radio and the base station implement closed loop control of tuning of a tunable transmit antenna of the radio. In this embodiment, the radio determines a transmission frequency parameter. The transmission frequency parameter may include an indication of the transmit frequency or channel assigned to the radio, or some other transmit parameter. The transmission frequency parameter may be retrieved from storage at the radio or may be received from external to the radio, such as by means of a radio link conveying control information to the radio. The radio begins transmission using the tunable antenna and in accordance with the transmission frequency parameter.

Signals transmitted by the radio are received at the base station. However, because of various factors, the signals may become detuned upon transmission from the radio. Two particular sources of detuning are grasping the radio in the hand of the user and placing the radio adjacent the head of the user. The result can be a change in the transmission frequency or transmission bandwidth.

Detuning may be detected at the base station in various ways, but one detection technique involves detecting power of the signals received from the radio. In general, power will be reduced as a result of detuning. The received power level may be compared with an expected or assigned power level. In many radio communication systems, the base station assigns a transmit power level to radios with which it communicates, taking into account other radio traffic and current environmental conditions. The assigned transmit power may be compared with the received power to identify an error condition or a detuning condition. By detecting reduced power or some other error condition, the base station determines that a detuning condition has occurred and that a retuning signal is required.

The base station transmits a correction signal or retuning signal to the radio. This signal may be part of the control information defined by the air interface specification, for example, by defining possible values for the retuning signal and location of the data in a transmission from the base station to the radio. The retuning signal may include an absolute value for the transmission frequency parameter which should be selected by the radio or may include an offset value by which the currently selected transmission frequency parameter should be adjusted.

The retuning signal is received at the radio. In one embodiment, the controller of the radio locates the retuning signal in the control data transmitted from the base station. This control data may include other information such as power control information for adjusting the transmit power of the radio. In response to the retuning signal, the controller produces a perturbation signal which is provided to the antenna control unit or other appropriate circuit to adjust the tuning of the transmit antenna. The transmit filter may be adjusted in a similar manner. In response to the perturbation signal, the tuning is adjusted to compensate for the detuning produced by, for example, the hand which holds the radio.

In one embodiment, the closed loop tuning control method is iterative. The base station continually detects for a detuning condition. If no detuning condition is detected, no retuning signal is generated or the retuning signal is generated with a value indicating no adjustment is necessary. If a detuning condition is detected, a retuning signal is generated and the process continues until the error condition is eliminated or the detuning condition is brought within an acceptable tolerance. Subsequent signals received from the radio at the base station are measured to continuously or periodically detect a detuning condition.

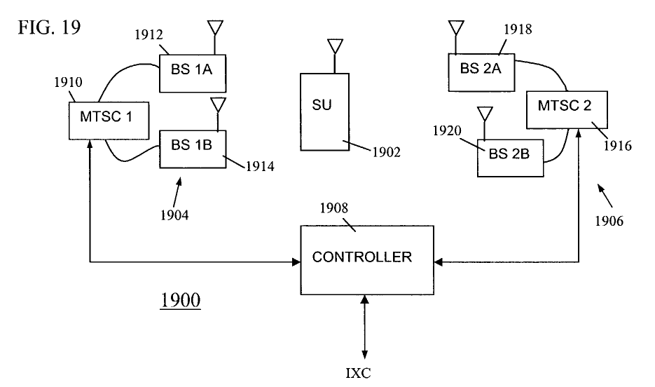

FIG. 19 is a block diagram of a telecommunication system 1900. The telecommunication system 1900 provides two-way radio communication with one or more subscriber units (SU) such as subscriber unit 1902. The telecommunication system 1900 includes a plurality of telecommunication networks, such as network 1904 and network 1906.

It is envisioned that the two networks 1904, 1906 are autonomous, independent networks operated by independent carriers or service providers. The telecommunication system 1900 is operated by a third party in association with the operators of the networks 1904, 1906. In one example, the operator of the system 1900 has contracts with the operators of the networks 1904, 1906 to resell air time on the networks 1904, 1906 to customers of the operator of the system 1900. While two networks 1900 are shown in FIG. 19, this is illustrative. Any number of networks may be interoperated. Also, non-networked, unlicensed devices, such as Bluetooth devices, may be operated in the system 1900.

The network 1904 includes a mobile telephone switching center (MTSC) 1910, a first base station 1912 and a second base station 1914. The embodiment of the network 1904 shown in FIG. 19 is exemplary only. The network 1904 may include any suitable number of switching centers such as MTSC 1910 and any suitable number of base stations such as base station 1912 and base station 1914. The base stations 1912, 1914 provide two-way radio communication with subscriber units such as subscriber 1902 in a geographic area surrounding the respective base stations. To establish and maintain radio communication, the base stations 1912, 1914 operate in accordance with an air interface standard. As described herein, examples of air interface standards include GSM, CDMA, TDMA, W-CDMA, etc. Examples of air interface standards also include air interface standards to be developed in the future to control radio communication between a first radio and a second radio. Other examples of air interface standards include future generations of cellular telephone standards, including those generally referred to as 2.5 G, third generation or 3 G and fourth generation or 4 G. Also, examples include standards according to or similar to IEEE standards 802.11B and A, satellite communication standards such as those associated with Iridium, Globalstar and others, and standards operated outside the United States such as personal digital cellular (PDC), personal handy phone system (PHS), Digital European Cordless Telephone (DECT), home RF, Bluetooth, and any other suitable wireless protocol.

The elements of the network 1904 communicate according to a standard wireline protocol. Examples of such a protocol include interim standard-41 (IS-41), GSM MAP, etc. The MTSC 1910 controls such functions as handoff of communication between one base station and another base station with the subscriber unit 1902. The MTSC 1910 also provides a telecommunication interface to the public switched telephone network (PSTN).

The network 1906 operates substantially similarly to operation of the network 1904. However, the network 1906 may operate in accordance with a different air interface standard, selected from any of those listed above or other suitable air interface standard. Thus, in one embodiment, the network 1904 is a GSM network and the network 1906 is a CDMA network according to interim standard IS-95. In another example, the network 1904 is a third generation cellular network and the network 1906 includes a group of interconnection Bluetooth devices. While the network 1906 is shown as having the same configuration as the network 1904, including a mobile telephone switching center 1916 and two associated base stations 1918, 1920, any suitable network architecture may be applied.

The networks 1904, 1906 may have at least partially overlapping coverage areas provided by the base stations. In some instances, the base stations may be collocated. A subscriber unit in a geographic area served by a base station may access and initiate communication with the base station if the subscriber unit is compatible with the air interface standard and frequency offered by the base station and if the subscriber unit has a subscription or other account information established with the network. It is envisioned that a subscriber unit such as subscriber unit 1902 will be able to initiate communication with any networked base station or non-networked radio or with another subscriber unit.

The controller 1908 controls interoperation of the networks 1904, 1906 and subscriber unit 1902. In particular, the controller 1908 controls transactions for blocks of telecommunication resources provided by service providers operating the respective telecommunication networks 1904, 1906. Each one of the transactions controlled by the controller 1908 represents a point in a four-dimensional space, including frequency bands, time (period or duration of contracted service), space or geographical location of coverage, and air interface standard. The frequency bands correspond to the frequencies of operation for respective networks such as network 1904 and network 1906. For example, a GSM system may be licensed and operable in a frequency band at 1900 MHz. Similarly, a DCS communication system may be licensed and operable at 900 MHz and 1800 MHz. The Bluetooth standard and its associated devices is operable in a frequency band around 2400 MHz. In one embodiment, the controller 1908 also includes a connection to one or more interexchange carriers (IXC) for wireline telecommunication services.

It is envisioned that whenever a subscriber unit such as the subscriber unit 1902 requests a call, a counterpart radio chooses the optimum combination of receive and transmit channel based on available telecommunication resources. The channel selection may be made after negotiation between the subscriber unit and the remote radio. The channel is assigned and communication is initiated. When communication on the channel is terminated, a billing event occurs. Identification and selection of the available telecommunication resources may be done anywhere in the system 1900. Information about available resources of the various networks, such as network 1904, network 1906, may be stored at the controller 1908 at one or more mobile telephone switching centers, or at one or more base stations. Information not immediately available at a base station for initiating a radio link with subscriber unit 1902 may be accessed from elsewhere in the system 1900, since other networks are in communication with the controller 1908.

Significantly, it is envisioned that separate receive and transmit channels are selected based on optimum quality of service, and without regard to frequency or air interface standard. The base stations of the respective networks, 1904, 1906 and the subscriber unit 1902 are provisioned with radio equipment suitable for operation on any reasonable frequency at any specified air interface standard. This allows flexibility to customize the respective transmit and receive channels, also referred to as the forward and reverse channels or uplink and downlink, to a particular communication.

Examples where different types of channels may be chosen for forward and receive channels include the following. In a first example, where the subscriber unit 1902 is accessing information of the World Wide Web, data transmitted from the subscriber unit 1902 is minimal, corresponding generally to navigation “clicks” around web pages. In contrast, World Wide Web data transmitted to the subscriber unit, may be substantial, including elaborate graphical, textual and other data. In such an example, an unbalanced channel pair may be preferred, such as a low-data rate GSM channel at 1900 MHz from the subscriber unit to a base station and a third generation cellular high data rate channel from a base station to the subscriber unit. Once the World Wide Web access has been terminated, and the subscriber unit is engaged only in a voice call, the channel combination may be altered to suit the changed communication requirements of generally lower speed data transmission for the voice call. In another example, the surrounding terrain or buildings may create extensive multipath interference, requiring a CDMA channel for reliable reception at the subscriber unit 1902 from a base station. However, the reverse link may be clear enough that an analog channel may be assigned according to the Advanced Mobile Phone System (AMPS) air interface standard. In a third example, revenues provided to the operator of the system 1900 may be greater, perhaps due to embedded advertisements from third party suppliers, for one type of downlink channel to a subscriber. In order to capture these revenues, the operator may bias the channel selection in favor of that type of downlink, other factors being equal. Thus, the particular resources assigned to a communication link required by a subscriber unit may be tailored according to the particular and varying requirements of the subscriber unit and the operator. Assignment is made under control of an authority such as the controller 1908 which also maintains subscription information, time and other resource usage information and billing records. Preferably, billing is also tailored to the particular requirements of the subscriber unit. In the case of one example above, a high data rate channel may be billed at a higher usage rate than a low data rate channel or a voice channel, or a channel including third party advertisements may be provided at a lower cost to the subscriber.

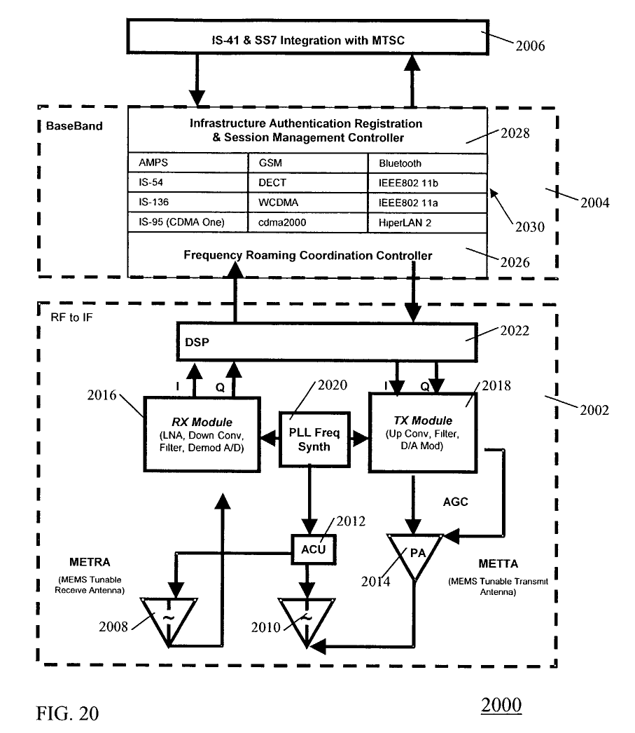

FIG. 20 is a block diagram of a base station 2000 for use in a telecommunication network of the telecommunication system of FIG. 19. The base station 2000 is configured for communication according to any applicable air interface standard, on any appropriate transmission or reception frequency or combination of frequencies. The base station 2000 includes a radio frequency (RF) to intermediate frequency (IF) section 2002, a baseband section 2004 and a wireline interface 2006.

The RF to IF section 2002 is generally constructed in accordance with any of the embodiments illustrated herein. The RF to IF section 2002 includes a tunable receive antenna 2008, a tunable transmit antenna 2010, an antenna control unit (ACU) 2012, a power amplifier 2014, a receive module 2016, a transmit module 2018, a frequency synthesizer 2020 and a processor 2022. The tunable receive antenna may be tuned to any particular receive frequency or band of frequencies under control of the antenna control unit 2012. The tunable receive antenna 2008 is preferably constructed in accordance with the embodiments described herein, or in accordance with any other suitable embodiment. Similarly, the tunable transmit antenna 2010 may be tuned to resonate at one or more frequencies or band of frequencies under control of the ACU 2012. Again, the tunable transmit antenna 2010 may be constructed in accordance with any embodiment disclosed herein, or other suitable embodiments. The antenna control unit 2012 provides the analog and/or digital signals necessary to control the tuning of the tunable receive antenna 2008 and the tunable transmit antenna 2010. Each of the receive antenna 2008 and transmit antenna 2010 may also include an integrated filter which is separately tunable, again under control of the ACU 2012.

The receive antenna 2008 feeds the receive module 2016. In general, the receive module 2016 may be constructed according to any suitable embodiment, and generally includes functions such as low noise amplification, down conversion, filtering, demodulation and analog to digital conversion. The receive module 2016 produces as its output in-phase and quadrature phase signals for the processor 2022.

For transmission, the transmit module 2018 receives in-phase and quadrature phase signals from the processor 2022. The transmit module may be constructed according to any suitable embodiment and provides, in general, functions of up conversion, filtering, digital to analog conversion and carrier modulation. The signal for transmission is provided from the transmit module 2018 to the power amplifier 2014 for amplification to feed the tunable transmit antenna 2010.

The frequency synthesizer 2020 produces the necessary time varying signals required for modulation and demodulation of carrier signals in the RF to IF section. The frequency synthesizer 2020 may include a crystal oscillator, phase locked loop or other appropriate devices.

The baseband section 2004 includes a frequency roaming coordination controller 2026 and infrastructure authentication registration and session management controller 2028 and customization data 2030. The controller 2026 provides control signals and data necessary to customize the RF to IF section 2002 for communication at a specified frequency or frequency band and in accordance with a specified air interface standard. The controller 2028 receives information indicating the selected frequency band and air interface standard for communication with a particular subscriber unit. Data defining the necessary operations for communicating with a subscriber unit in accordance with a variety of air interface standards is stored as the configuration data 2030, as indicated in FIG. 20. Thus, for preparing a message for a paging channel or data channel or any other communication for transmission to a subscriber unit, the controller 2026 consults the configuration data 2030 for the specified air interface standard. Similarly, for decoding a received communication from a subscriber unit, the controller 2026 consults the stored configuration data.

The wireline interface 2006 provides data communication over a wireline link to other components of a telecommunications network, such as communications to the mobile telephone switching center (MTSC). Communications with the MTSC are in accordance with interim standard IS-41 and according to signaling system 7 (SS7). Other equivalent switching and communication systems may be substituted.

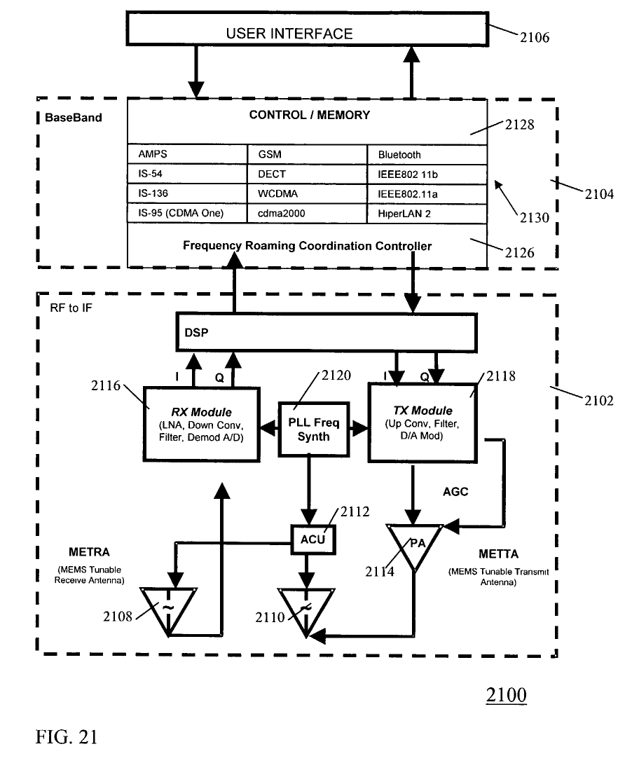

FIG. 21 is a block diagram of a subscriber unit for use in a telecommunication network of the telecommunication system of FIG. 19. The subscriber unit 2100 includes a radio frequency (RF) to intermediate frequency (IF) section 2102, a baseband section 2104 and a user interface 2106.

The RF to IF section 2102 includes a tunable receive antenna 2108, a tunable transmit antenna 2110, an antenna control unit 2112, a power amplifier 2114, a receive module 2116, a transmit module 2118, a frequency synthesizer 2120 and a processor 2122. The respective components of the RF to IF section 2102 are shown in FIG. 21 as substantially identical to the complementary components of the RF to IF section 2002 of the base station 2000 of FIG. 20. It is intended that these RF to IF sections 2002,2102 will be completely complementary so as to allow complete flexibility in selecting communication resources for communication between the base station 2000 and the subscriber unit 2100. In some embodiments, some functionality provided in the base station 2000 may be omitted from the subscriber unit 2102. Also, physical embodiments of the functional blocks shown in FIG. 21 may be different from the physical embodiments realized in the base station 2000, due to design goals related to cost, weight, size and power drain. However, substantially the same functionality is provided by the RF to IF section 2102 as is provided by the RF to IF section 2002 (FIG. 21).

The baseband section 2104 is similarly substantially identical in function to the baseband section 2004 of the base station 2000 illustrated in FIG. 20. The baseband section 2104 includes a frequency roaming coordination control 2126, a controller and memory 2128 and configuration data 2130. The controller 2126 receives information defining the frequencies for communication and the error interface standard for communication with a remote radio such as the base station 2000. The configuration data 2130 includes the data necessary to define communication according to any suitable standard, including those illustrated in FIG. 21.

The controller and memory 2128 control overall operation of the subscriber unit 2100 and may include a timing source such as a clock or oscillator to control timing. Data and instructions are stored in memory for operation by the controller. The user interface 2106 generally includes a keypad, display, microphone and earpiece.

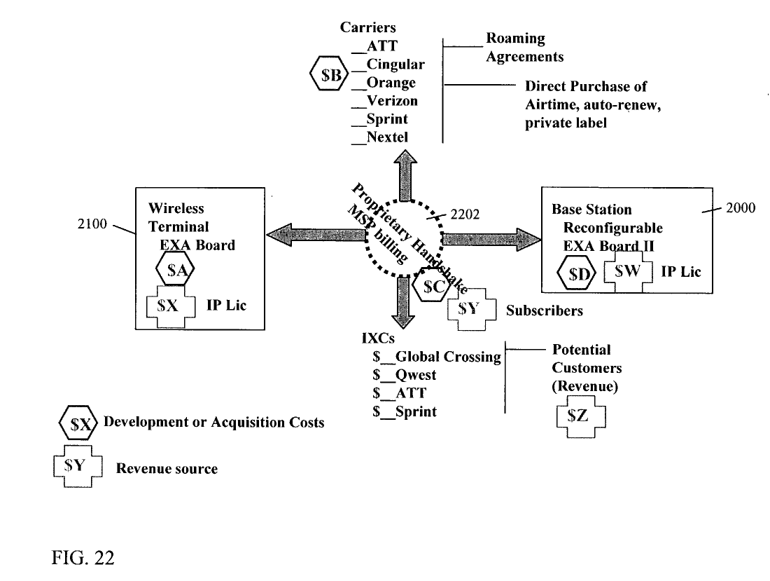

FIG. 22 is a block diagram illustrating interoperation of elements in performance of a method in accordance with the presently disclosed embodiments. In the block diagram of FIG. 22, a base station 2000 is configured for wireless communication with a subscriber unit or wireless terminal 2100. The wireless terminal 2100 is equipped with a circuit referred to in FIG. 22 as the EXA board. The base station 2000 is similarly equipped with a circuit referred to in FIG. 22 as the EXA board II. The EXA board generally corresponds to the RF to IF section 2102 (FIG. 21). Similarly, the EXA board II generally corresponds to the RF to IF section 2002 (FIG. 20). These circuits operate in complementary fashion to provide reconfigurable wireless communication at any selected frequency and at any selected error interface standard.

The base station 2000 and wireless terminal 2100 are linked in the center of FIG. 22 by an interoperating component 2202. The interoperating component 2202 is preferably a combination of hardware and software to provide the reconfigurable, customizable channel selection described herein, along with communication with affiliated networks such as networks 1904, 1906 of FIG. 19. When a communication link is desired between the wireless terminal 2100 and a base station 2000, an optimum combination of receive and transmit channels is chosen under control of the interoperating component 2202. The interoperating component 2202 may include or be a part of the controller 1908 of FIG. 19. The interoperating component 2202 further provides features such as a proprietary hand shaking to ensure that only authorized subscribers may access the system or that only authorized telecommunication resources of service providers are accessed. Further, the interoperating component 2202 provides functions such as billing and account maintenance.

The upper portion of FIG. 22 illustrates potential revenue sources in accordance with the embodiments described herein. First, roaming agreements may be transacted with carriers or service providers such as those listed in FIG. 22. A roaming agreement allows a subscriber to a first carrier service to operate on a network of a second carrier, perhaps with some exchange of economic value. A second revenue source involves direct purchase and resale of airtime, for example by the operator of the interoperating component 2202. The operator of the interoperating component 2202 and the telecommunication system 1900 of FIG. 19 purchases airtime from one or more carriers such as those listed in FIG. 22 for resale to subscribers operating wireless terminals. The airtime can then be resold to the subscribers to meet subscriber demand and in accordance with other factors such as traffic and physical system requirements. The airtime can be combined with other value added features provided to subscribers by the operator of the interoperating component 2202, such as tailored advertisements, information such as maps and geographic location or directions, referrals to restaurants or other points of interest, connection to long distance service, and so forth.

The bottom portion of FIG. 22 illustrates potential customers for the operator of the interoperating component 2202 and the system 1908. These customers include interexchange carriers which provide long distance, high volume telecommunications services, examples are listed in FIG. 22. Telecommunication traffic generated by wireless terminals and intended for remote locations outside of the telecommunication networks operated by the carriers which are affiliated with the operator of the interoperating component 2202 may be routed to networks operated by the interexchange carriers. The interexchange carriers will charge a fee for the service of carrying this traffic, which can be charged back to, for example the operator of the wireless terminal.

Other revenue sources for the operator illustrated in FIG. 22 include licensing revenues generated by installation of the EXA boards in the wireless terminal 2100 and the base station 2000. In one embodiment, licensing revenues may be generated for each EXA board sold or for each usage of the technology embodied in the EXA board, for example, when a call is completed through the EXA board or EXA board II. In another embodiment, a paid-up license may be transacted, with the operator collecting a single licensing fee.

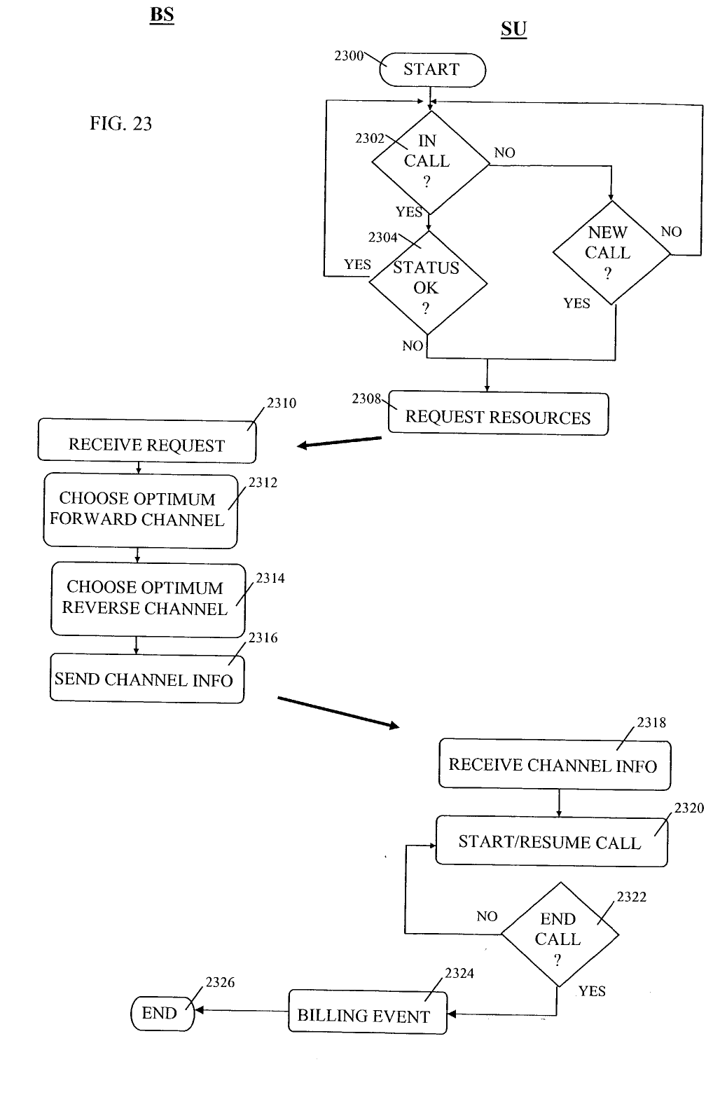

FIG. 23 is a flow diagram illustrating a method for operating the telecommunication system of FIG. 19. FIG. 23 illustrates method performed at both a base station (BS) and subscriber unit (SU) of the telecommunication system. In an alternative embodiment, the method or a variation thereof may be performed between a subscriber unit and a non-networked radio such as a Bluetooth radio. The method begins at block 2300.

At block 2302, it is determined if the subscriber unit is currently engaged in a call. A call corresponds to an ongoing telecommunication link over assigned transmit and receive channels with a base station. If the subscriber unit is engaged in a call, at block 2304 it is determined if the status of the call is acceptable. For example, if interference prevents reliable transmission and reception of data and other information, the status of the call will no longer be acceptable. Further, if the requirements of the subscriber have changed, for example requiring a higher data rate radio link, the status of the call will no longer be acceptable. If the status is acceptable, control returns to block 2302 and remains in a loop including blocks 2302, 2304. If the status is not acceptable, control proceeds to block 2308.

If the subscriber unit is not currently in a call, at block 2306 it is determined if the subscriber desires to initiate a new call. If not, control returns to block 2302. If a new call is desired, at block 2308, a request for resources is initiated. The request is communicated to a base station of the system. The base station may be the closest base station, one with the best available signal quality, or one specifically operated for negotiation of resources for calls with subscribers.

The request may be initiated in any suitable format. For example, the subscriber unit may identify a communication initiation channel, defined by predetermined timing and frequency parameters, and communicate the request for resources on the identified channel. The base station may be continually scanning the channel to identify new request for resources from the subscriber unit. The request for resource may include identifying information and resource specific information. For example, the request for resources may include an electronic serial number (ESN) of the subscriber unit, a specification of the capabilities of the subscriber unit or a specification of particular requirements of a subscriber unit. Particular requirements can include such factors as a wide band communication channel, a high data rate communication channel, specified for either the forward link or reverse link from the base station. Other information in the request might include a willingness to receive third party advertising or other information, or a blocking indication for such information. Other examples may apply as well.

At block 2310 the request for resources is received at the base station. At block 2312 resources appropriate for an optimum forward channel are chosen. Similarly, at block 2314 resources appropriate for an optimum forward channel are chosen. The optimal condition may differ for the forward channel and for the reversre channel. The optimal condition may differ depending on the current time or the schedule time for the communication. The optimal condition may vary depending upon the physical or geographic location of the subscriber unit. Factors to be considered in choosing the optimal forward channel and optimal reverse channel include requirements of the subscriber unit, traffic at the time required for communication, alternatives at the geographic location, such as coverage available for more than a single service provider, and other physical and software limitations. Alternatively, a forward and reverse channel pair may be chosen and assigned together, in common frequency bands and with a common air interface standard.

At block 2316, identifying information for the transmit and receive channels is communicated to the subscriber unit. The identifying information may specify frequency or frequency band for communication, an interface standard, system identifying information for registration by the subscriber unit, and timing information for system acquisition by the subscriber unit. The information is received at the subscriber unit at block 2318.

At block 2320, the subscriber unit either initiates or resumes a call. The subscriber unit remains in the call, possible handing off the call from one base station to another base station, for the duration of the call. As conditions change, the optimal forward or reverse channel may change, and additional channel identifying information may be communicated from the base station to the subscriber unit. For example, if the required data rate of the subscriber unit changes, a new, higher data rate channel may be assigned, which may involve selecting a different error interface standard, a different frequency band for communication, etc. Also, if the subscriber unit is mobile, communication may have to be handed off from one base station to another base station. During each handoff, optimal transmit channel and receive channel are identified and the channel identification information is conveyed to the subscriber unit. Based on system capabilities and other limitations, the nature of the individual uplink and downlink channels may change during handoff. Preferably, the handoff is seamless and imperceptible to the subscriber using the subscriber unit.

At block 2322, it is determined if the call has ended. If not, control returns to block 2320 and the call continues. If the call has ended, at block 2324 a billing event occurs. The billing event may include a charge for airtime entered against an account of the subscriber associated with the subscriber unit. The billing event may further include a license royalty charge entered against an account of the subscriber and a license royalty charge entered against an account of one or more service providers whose base station and other equipment was in communication with the subscriber during the call. The billing event may further include an entry in an account associated with roaming agreements entered into among service providers and the system operator. The billing event may still further include acknowledgement of charges incurred to one or more interexchange carriers for communication of data between the subscriber unit and a remote source accessed over facilities of the interexchange carrier. The method ends at block 2324.

While particular embodiments of the present invention have been shown and described, modifications may be made. It is therefore intended in the appended claims to cover such changes and modifications which follow in the true spirit and scope of the invention.

1. A telecommunications method comprising:
selecting a block of radio communication resources including one or more of
frequency band,
time,
geographic space, and
air interface standard;
communicating to a remote receiver information about the selected resources; and
initiating communication in accordance with the selected resources.

2. The method of claim 1 wherein selecting comprises:
selecting optimum resources for a forward channel; and
selecting optimum resources for a reverse channel.

3. A telecommunications system comprising:
a plurality of autonomous telecommunication networks operable to provide two-way telecommunication service for subscriber unit radios within one or more predetermined geographic areas;
a controller configured to select blocks of telecommunication resources including one or more of
frequency band of one or more of the autonomous telecommunication networks,
call time duration of one or more of the autonomous telecommunication networks,
base station radio equipment of one or more of the autonomous telecommunication networks, and
an air interface standard used by one or more of the autonomous telecommunication networks.

4. A telecommunication method comprising:
identifying assignable wireless telecommunication resources of a plurality of wireless telecommunication service providers;
identifying a subscriber requirement for telecommunication resources;
verifying configurable subscriber equipment of the subscriber and configurable service provider equipment of one of the plurality of wireless telecommunication service providers suitable for two-way wireless communication;
allocating at least a portion of the assignable wireless telecommunication resources for use in satisfaction of the subscriber requirement.

5. The method of claim 4 further comprising:
billing at least one of the subscriber and a service provider associated with the at least a portion of the assignable wireless telecommunication resources.

6. The method of claim 4 wherein the assignable wireless telecommunication resources comprise at least one of
frequency band,
time duration of a communication,
geographic space, and
air interface standard.

7. The method of claim 4 wherein verifying comprises:
determining capabilities of the configurable subscriber equipment and configurable service provider equipment; and
identifying a match among the capabilities.

8. The method of claim 7 further comprising:
selecting an optimal transmission channel for a call between the configurable subscriber equipment and configurable service provider equipment; and
selecting an optimal reception channel for the call.
